(19) United States
(12) Patent Application Publication
(10) Pub. No.: US 2024/0150939 A1
(43) Pub. Date: May 9, 2024

(54) GRAPHENE INCORPORATED POLYMER FIBRE, CORRESPONDING FABRIC, PROCESS OF PREPARATION, AND APPLICATIONS THEREOF

(71) Applicant: RELIANCE INDUSTRIES LIMITED, Mumbai (IN)

(72) Inventors: Vivek Prabhakar RAJE, Thane (IN); Joseph Berkmans AMIRTHASAMY, Sivaganga (IN); Vijay Kumar GARG, Navi Mumbai (IN); Pushap SUDAN, Jammu (Tawi) (IN); Abhijit Vasantrao KASHETWAR, Navi Mumbai (IN); Santosh HUILGOL, Thane (IN); Debarati Roy CHOWDHURY, Kolkata (IN)

(21) Appl. No.: 18/549,818

(22) PCT Filed: Mar. 9, 2022
(86) PCT No.: PCT/IB2022/052091

§ 371 Date: Sep. 8, 2023

(30) Foreign Application Priority Data
Mar. 11, 2021 (IN) 202121010359

(51) Int. Cl. D01F 1/10; C01B 32/194; D01D 1/02; D01F 6/62

(52) U.S. Cl. CPC D01F 1/103; C01B 32/194; D01D 1/02; D01F 1/106; D01F 6/62; C01B 2204/02; C01B 2204/32; D10B 2331/04; D10B 2401/04; D10B 2401/13; D10B 2401/22

(57) ABSTRACT

Polymer fiber or corresponding fabric including graphene and/or its derivative(s), wherein the graphene including polymer fabric is characterized by feature selected from the group consisting of anti-microbial, antistatic, wicking, thermal cooling, anti-odour, and ultraviolet protection, or any combination thereof. The graphene including polymer fiber or fabric shows several further beneficial properties including but not limited to good/excellent washing fastness, rubbing fastness, perspiration fastness, sublimation fastness, and light fastness. A process by which the graphene and/or its derivative(s) is incorporated in a polymer during its synthesis. The polymer is subsequently drawn into a fiber or fabric, and is capable of being converted into commercial products. A method to improve the aforementioned properties in a polymer fiber or fabric.

### TECHNICAL FIELD

The present disclosure generally relates to the field of textile technology and pertains to polymer fabric such as those made of polyester fibre possessing feature selected from a group comprising anti-microbial, antistatic, wicking, thermal cooling, anti-odour and ultraviolet protection, or any combination thereof. More particularly, the present disclosure provides polymer fibre comprising graphene and/or its derivative(s), wherein said graphene incorporated polymer fibre is converted to fabric and characterized by at least one of the above features. Said polymer fibre has graphene loaded in the matrix and therefore exhibit permanent functional properties which do not fade with washing. The present disclosure accordingly also provides a corresponding process by which the graphene and/or its derivative(s) is incorporated in a polymer during its synthesis. The polymer is subsequently drawn into a fibre or fabric, and is capable of being converted into commercial products.

### BACKGROUND OF THE DISCLOSURE

Polymer fibre (synthetic) such as polyester are widely used to make fabric to be used as garment materials, sports wears, apparels in hospitals, medical devices, air purifiers and auto motive textile applications due to its high tenacity and durability. However, virgin polymer fabrics have tendency to absorb moisture and grow microorganisms such as bacteria and fungi on their surface and don't have any inherent ability to hamper the growth of microorganisms. Such microorganisms cause adverse effects to the textiles and the consumers. Controlling the growth of microorganisms on fabrics to avoid pathogenic effects has received much attention in recent years that paved the development of antimicrobial textiles. The antimicrobial fabrics reduce unpleasant odors by controlling the growth of microorganisms makes the user feel fresh after the usage of the textiles, which is the most demanded property in medical applications such as aprons, garments, furniture covers, bed covers, pillow covers, curtains etc. in the hospitals. The pathogenic effects are caused by many gram positive and gram negative bacterial species, most importantly Staphylococcus aureus, Klebsiella pneumonia, and Escherichia coli, viral and fungal species. Many anti-microbial agents and their use in preparing anti-microbial textiles are known. For instance, silver nanoparticles are known to be effective and is a widely studied anti-microbial agent for textile applications. However, cost and the release of the metallic nanoparticles to the environment remain to be challenges.

Further, static charge build up on the fibre and hence clothing, carpeting and other textile products is another long recognized problem for textile manufacturer and consumers. For example, unprocessed grey polyester fibre and its fabrics accumulate static charges on their surface naturally which affects the comfort of the polymer fabric in many applications such as apparels. Anti-static agents generally employed in the art typically increase the electrical conductivity of the polymer fabric by forming hygroscopic intermediate layers on the polymer fabric surface that absorb moisture and enhance conductivity. However, said absorption of moisture for achieving anti-static effect interferes with properties such as wicking and thermal cooling. Said properties of wicking and thermal cooling are extremely important for the comfort of the wearer especially in the case of garments such as sportswear wherein anti-microbial effect of the polymer fabric is also important for purposes of hygiene. There are also various additives used at the finishing stage to impart antistatic property to the fibre/fabric for eg: organic amines and amides, polyhydric alcohols, esters of salts of alkylphosphonium acids, betaine amphoteric surfactant, polyethylene glycol fatty acid ester etc. Such agents, however, suffer from lack of durability and are washed away during repeated washing cycle. The filaments are also treated with antistatic finish, but it is found to be lost in subsequent processing steps involving mechanical handling, heating, washing, and dyeing.

Another challenge comes in the form of development of fibre that can form a fabric that provides a cooling sensation when worn and touched and is hence a growing area in textile industry. Efforts to develop such fibre/fabric includes infusion of thermal conductive filler into the fibre, introduction of resin containing hydrophilic groups during the manufacturing of fibre, treating the fibre with functional additive etc. However, in many cases the final fabric does not reveal significant cool touch effect when it is actually subjected to a sensory test by human. In most of the cases, to achieve sufficient cool contact effect, large quantities of additives are required which leads to a compromise on the quality of texture and touch feel effect of the fibre/fabric. Also, this thermal cooling property is temporary and diminishes after washing of the fibre/fabric.

Yet another feature that is desired from a fibre/fabric is its ability to protect the human skin from sunlight, particularly UV radiation. There is hence an urgent need for development of fibre/fabric with UV blocking property. UV resistant additives can be introduced in various stages of fibre, yarn and fabric manufacturing and processing steps. Widely used UV screening additives are benzophenone compounds, triazole compounds, benzoic acid compounds, zinc oxide, titanium oxide etc. However, the organic reflecting agent suffers from potential toxicity and inorganic blocking agent imparts inferior stability and inadequate efficiency.

Taken together, there is a requirement for polymer fibre/fabrics possessing a combination of multiple beneficial characteristics as a whole, wherein all characteristics exist simultaneously without interfering with each other. Also, these properties should last till the life of the fibre/fabric. The present disclosure tries to address the said need.

### SUMMARY OF THE DISCLOSURE

Addressing the aforesaid need in the art, the present disclosure provides a polymer fibre/fabric comprising graphene or its derivative at an amount ranging from about 0.0001% (w/w) to 1% (w/w), or about 1 ppm to about 10000 ppm, said polymer fibre/fabric characterized by feature selected from a group comprising antimicrobial, antistatic, anti-odour, wicking, thermal cooling and ultraviolet protection, or any combination thereof.

In some embodiments, the polymer fabric is made of polymer fibre such as polyester fibre or filament prepared in the presence of graphene, a graphene derivative or a combination thereof.

In some embodiments, the graphene is a combination of single and multi-layered graphene, and comprises about 80% to about 85% of single layered graphene, and about 15% to about 20% multi-layered graphene, wherein the multi-layered graphene is made up of about 2 to about 5 layers of graphene, having a surface area ranging from about 300 m²/g to about 800 m²/g, or about 400 m²/g to about 500 m²/g; and the polymer is polyester.

In some embodiments, the graphene is incorporated within the polymer at an amount ranging from about 50 ppm to about 200 ppm.

In some embodiments, at least one of the features selected from a group comprising antimicrobial, antistatic, anti-odour, wicking, thermal cooling and ultraviolet protection is enhanced by at least about 10% when compared to a polymer fibre or fabric lacking graphene or its derivative.

In some embodiments, the antimicrobial, antistatic, anti-odour, wicking, thermal cooling and ultraviolet protection features of the polymer fibre/fabric of the present disclosure are permanent up to at least 20 washes, and even up to the life of the fibre.

In some embodiments, the present disclosure achieves the antimicrobial, antistatic, anti-odour, wicking, thermal cooling and ultraviolet protection features of the polymer fibre/fabric without compromising the hand-feel, texture and visual aspects of the final fabric.

The present disclosure further provides a process of preparing a polymer fibre/fabric comprising graphene or its derivative, said polymer fibre/fabric characterized by feature selected from a group comprising antimicrobial, antistatic, anti-odour, wicking, thermal cooling and ultraviolet protection, or any combination thereof, the process comprising incorporating or infusing graphene at an amount ranging from about 0.0001% (w/w) to 1% (w/w), or about 1 ppm to about 10000 ppm, within the polymer fibre such as polyester fibre that forms the polymer fabric of the present disclosure.

In some embodiments, the process of preparing the polymer fibre or fabric comprises incorporating graphene or its derivative during synthesis of the polymer, and drawing the polymer into a fibre optionally followed by converting it to a fabric.

In some embodiments, the graphene is incorporated or infused in situ during synthesis of the polymer.

In some embodiments, incorporating or infusing the graphene during synthesis of the polymer comprises:
a) preparing a slurry or graphene or its derivative;
b) mixing an esterified mixture of polymer precursor with the graphene slurry; and
c) subjecting the mixture to polymerization to prepare the polymer comprising graphene or its derivative.

In some embodiments, the process incorporates or infuses graphene within the polymer fibres such as polyester fibres that form the polymer fabric of the present disclosure.

In some embodiments, the process of synthesis of the graphene incorporated polymer comprises steps of:
a) mixing a polymer precursor with an organic solvent to form a polymer precursor slurry;
b) optionally adding a catalyst and/or a contaminant suppressant to the slurry;
c) esterifying the slurry of step (a) or (b) to obtain an esterified mixture;
d) adding a slurry of graphene or its derivative prepared in an organic solvent to the esterified mixture;
e) subjecting the mixture obtained at the end of step (d) to polymerization to prepare the graphene incorporated polymer.

The present disclosure also provides a method of improving one or more characteristic of a polymer fibre or fabric, said method comprising act of incorporating graphene or its derivative during synthesis of the polymer.

In some embodiments, the graphene or its derivative is incorporated after the step of esterification of the polymer precursors, but prior to step of polymerization of the said precursors, during the synthesis of the polymer.

The present disclosure further provides use of graphene at an amount ranging from about 0.0001% to 1% (w/w), or about 1 ppm to about 10000 ppm, for preparing a polymer fibre/fabric made of polymer fibre such as polyester fibre characterized by feature selected from a group comprising antimicrobial, antistatic, anti-odour, wicking, thermal cooling and ultraviolet protection, or any combination thereof.

### DETAILED DESCRIPTION OF THE DISCLOSURE

In view of the limitations discussed above, and to remedy the need in the art for polymer fabric products characterized by property selected from a group comprising anti-microbial, anti-static, anti-odour, wicking, thermal cooling and ultraviolet protection, or any combination thereof, the present disclosure aims to provide a polymer fabric comprising graphene at a controlled concentration. In particular, the present disclosure relates to a polymer fabric, such as a polyester fabric, comprising graphene and/or its derivatives incorporated into it. Said graphene is incorporated or infused in situ during synthesis of the polymer that forms the fibre for the polymer fabric. The disclosure also provides a corresponding process for preparing such graphene containing polymer fabric and corresponding beneficial properties obtained thereof.

However, before describing the invention in greater detail, it is important to take note of the common terms and phrases that are employed throughout the present disclosure for better understanding of the technology provided herein.

Throughout the present disclosure, the term ‘graphene’ is intended to convey the ordinary conventional meaning of the term known to a person skilled in the art and intends to cover ‘graphene’ as an allotrope of carbon consisting of a single or multiple layers of carbon atoms. However, in the context of the present disclosure, the graphene employed in the present disclosure is a combination of single and multi-layered graphene, and comprises about 80% to about 85% of single layered graphene, and about 15% to about 20% multi-layered graphene, wherein the multi-layered graphene is made up of about 2 to about 5 layers of graphene. Thus, the graphene employed in the present disclosure is a mixture of single and multi-layered graphene. Further, since such a graphene combination will ultimately structurally comprise more than one layer of graphene, to avoid repetition of the description of this combination, the term ‘multi-layered graphene’ employed in the present disclosure is also used to collectively describe this combination of single and multi-layered graphene. Thus, the term ‘multi-layered graphene’ used in any embodiment, example or claim of the present disclosure is used to mean that the graphene present is a combination of single and multi-layered graphene, and comprises about 80% to about 85% of single layered graphene, and about 15% to about 20% multi-layered graphene, wherein the multi-layered graphene is made up of about 2 to about 5 layers of graphene. The graphene employed herein is preferably of high surface area, typically ranging between 100 m²/g to 2000 m²/g, more typically between 300 m²/g to 800 m²/g. In non-limiting embodiments, the surface area of graphene incorporated into the polymer fabric of the present disclosure is about 100 m²/g, about 200 m²/g, 300 m²/g, 400 m²/g, 500 m²/g, 600 m²/g, 700 m²/g, 800 m²/g, 900 m²/g, 1000 m²/g, 1100 m²/g, 1200 m²/g, 1300 m²/g, 1400 m²/g, 1500 m²/g, 1600 m²/g, 1700 m²/g, 1800 m²/g, 1900 m²/g or 2000 m²/g.

Throughout the present disclosure, the term ‘graphene derivatives’, ‘derivatives of graphene’ or the likes is intended to convey the ordinary conventional meaning of the term known to a person skilled in the art and intends to cover structural analogs of graphene, or compounds derived from graphene and having similar characteristics of graphene. In some embodiments of the disclosure, graphene derivatives encompass graphene nanoplatelets, graphene oxides, reduced graphene oxides, functionalized graphene, graphene decorated with metal particles, nanosized graphene, graphene quantum dots or any graphene containing material. However, in the context of the present disclosure, any derivative of graphene must in-turn be a combination of single and multi-layered graphene derivative, and comprise about 80% to about 85% of single layered graphene derivative, and about 15% to about 20% multi-layered graphene derivative, wherein the multi-layered graphene derivative is made up of about 2 to about 5 layers of graphene.

Further, all references to graphene within the present disclosure also intends to cover its derivatives, unless explicitly stated otherwise. Thus, any embodiment referring to graphene is meant to be extrapolated to any derivative of graphene as well, unless explicitly stated otherwise.

In embodiments of the disclosure, graphene derivatives encompass functionalized graphene. Further, said term ‘functionalized’ or ‘functionalization’ is used interchangeably and is intended to convey the ordinary conventional meaning of the term known to a person skilled in the art in the field of polymer or material science, and intends to cover a process of adding new molecules, functions, features, capabilities, or properties to a material by changing the surface chemistry of the material. In the context of graphene employed in the present disclosure, the term is used to cover functionalization of graphene including reactions of graphene (and its derivatives) with organic and/or inorganic molecules, chemical modification of the graphene surface, and the interaction of various covalent and noncovalent components with graphene.

The functionalization of graphene is surface modification used to reduce the cohesive force between the graphene sheets and to manipulate the physical and chemical properties of graphene.

Throughout the present disclosure, the terms ‘fabric’, ‘fibre’, ‘yarn’, ‘textile’, ‘cloth’ or ‘filament’ or the likes are intended to convey the ordinary conventional meaning of the terms known to a person skilled in the art and intends to cover ‘fabric’, ‘fibre’, ‘yarn’, ‘textile’, ‘cloth’ or ‘filament’ made of polymer. Thus, any reference to the above terms intend to represent ‘polymer fabric’, ‘polymer fibre’, ‘polymer yarn’, ‘polymer textile’, ‘polymer cloth’ or ‘polymer filament’. Thus, in the context of the present disclosure, the above terms intend to cover natural polymer fabric, synthetic polymer fabric and blends of natural and/or synthetic polymer fabric. In some embodiments of the disclosure, the term ‘polymer fabric’ also encompasses ‘fibres’ or ‘yarn’ forming said polymer fabric. Accordingly, in the context of the present disclosure, reference to ‘graphene-containing polymer fabric’ envisages ‘graphene-containing fibre’ and ‘graphene-containing yarn’. A person skilled in the art understands that in this field, filament or fibre come together to form yarn, which is then used to make fabric or textile. Thus, in the context of the present disclosure, emphasis is laid on incorporating graphene in a polymer fabric, wherein this fabric could be made of polymer fibre or filament, such as polyester fibre or filament. Thus, use of each of the above mentioned terms intend to represent the fact that the final product of the disclosure, which could be a fibre, filament, yarn, fabric or textile is made of polymer and comprises graphene, which is incorporated therein, during synthesis of the polymer.

Throughout the present disclosure, the terms/phrases ‘graphene infused polymer fabric’ or ‘graphene incorporated polymer fabric’ or ‘polymer fabric comprising graphene’ or ‘graphene-containing polymer fabric’ or the likes, are used interchangeably and refer to the feature of polymer fabric comprising graphene incorporated, impregnated or infused into it.

The term ‘anti-microbial’ and obvious variants thereof as used in the present disclosure, refers to the characteristic of the polymer fabric of the present disclosure that exerts destructive or inhibitory effect on the growth of microorganisms, including bacteria, viruses, and fungi. In the present disclosure, testing of anti-microbial characteristics has been carried out by the conventionally employed JIS L 1902 test method.

As used herein, the term ‘anti-bacterial’ refers to bacteriostatic or bactericidal activity of the polymer fabric, wherein ‘bacteriostatic’ typically means that the fabric prevents the growth of bacteria (i.e., it keeps them in the stationary phase of growth), and ‘bactericidal’ means that it kills bacteria. While, categorizing a fabric into a pure bacteriostatic or bactericidal fabric is difficult, the present disclosure aims to cover fabric that exhibit one or both characteristics.

As used herein, the term ‘anti-viral’ refers to the ability of the polymer fabric to kill a virus or suppress its ability to replicate and, hence, inhibits its capability to multiply and reproduce.

As used herein, the term ‘anti-fungal’ refers to the ability of the polymer fabric to limit or prevent the growth of yeasts and other fungal organisms.

The term ‘anti-static’ and obvious variants thereof refer to the characteristic of the polymer fabric of the present disclosure typically relating to reduction or elimination of build-up of static electricity.

The term ‘wicking’ and obvious variants thereof refer to a technical feature of the polymer fabric of the present disclosure which draws moisture away from the body. Such fabrics use capillary action to ‘wick’ sweat away from the skin. These are also interchangeably referred to as wicking fabrics. In the present disclosure, testing of wicking properties has been carried out by the conventionally employed AATCC 197:2013 method.

The term ‘thermal cooling’ and obvious variants thereof refer to the characteristic of the polymer fabric that allows thermal regulation due to the thermal conductivity of the polymer fabric. Said feature allows body heat to pass through the polymer fabric by conduction/convection to the ambient environment. In the present disclosure, testing of characteristics relating to thermal cooling has been carried out by the conventionally employed KAWABATA System using KES-F7 instructions.

The term ‘UV protection’ and obvious variants thereof refer to the protective effect exerted by the polymer fabric against sun's ultraviolet (UV) radiation. Unless otherwise mentioned, Ultraviolet Protection Factor (UPF) is used as a measuring parameter of the ‘UV protection’ characteristic of the polymer fabric. In the present disclosure, testing of UV protection characteristics has been carried out by the conventionally employed AATCC 183-2014 method.

‘Blend’ in the context of the present disclosure refers to ‘blended polymer fabric’ or a ‘polymer fabric blend’, wherein said blended polymer fabric is formed from polymer fibres or yarn formed by combining fibres of different origins, length, thickness, or colour. Blends can therefore contain different natural and/or synthetic fabrics.

In the present disclosure, the terms ‘feature’, ‘property’ and ‘characteristic’ are used interchangeably to describe and in relation to qualities present in the polymer fibre or fabric of the present disclosure. These qualities include anti-microbial, antistatic, anti-odour, wicking, thermal cooling and ultraviolet protection. These qualities are directly related to the structural make-up of the polymer fibre or fabric of the present disclosure, and are therefore also used to physically describe the said fibre or fabric.

Accordingly, to reiterate, the present disclosure relates to a polymer fibre/fabric product comprising graphene and/or its derivatives infused or incorporated in it, wherein said polymer fabric is specifically characterized by feature selected from a group comprising anti- microbial, antistatic, anti-odour, wicking, thermal cooling and ultraviolet protection, or any combination thereof.

Particularly provided by the present disclosure is a polymer fibre/fabric, such as a polyester fibre/fabric, comprising graphene at an amount ranging from about 0.0001% (w/w) to 1% (w/w), said polymer fabric characterized by feature selected from a group comprising anti-microbial, antistatic, anti-odour, wicking, thermal cooling and ultraviolet protection, or any combination thereof. In terms of parts-per-million (ppm) units, the polymer fibre/fabric of the present disclosure comprises about 1 ppm to about 10000 ppm of graphene.

In some embodiments, the present disclosure relates to polymer fibre(s) comprising graphene at an amount ranging from about 0.0001% (w/w) to 1% (w/w), or about 1 ppm to about 10000 ppm, said fibre(s) characterized by feature selected from a group comprising anti-microbial, antistatic, anti-odour, wicking, thermal cooling and ultraviolet protection, or any combination thereof.

In some embodiments, the present disclosure relates to polymer yarn(s) comprising graphene at an amount ranging from about 0.0001% (w/w) to 1% (w/w), or about 1 ppm to about 10000 ppm, said yarn(s) is characterized by feature selected from a group comprising anti-microbial, antistatic, anti-odour, wicking, thermal cooling and ultraviolet protection, or any combination thereof.

As defined above, the graphene incorporated polymer fabric comprises graphene and/or its derivatives at a concentration ranging from about 0.0001% (w/w) to 1% (w/w), or about 1 ppm to about 10000 ppm with respect to the weight of the polymer fabric, including all values or ranges derivable therefrom. Said graphene-containing polymer fabric of the present disclosure is further characterized by the mandatory presence of feature selected from a group comprising anti-microbial, antistatic, anti-odour, wicking, thermal cooling and ultraviolet protection, or any combination thereof.

In some embodiments, the graphene incorporated polymer fibre/fabric of the present disclosure comprises graphene and/or its derivatives at a concentration ranging from about 0.0001% (w/w) to 1% (w/w), or about 1 ppm to about 10000 ppm with respect to the weight of the polymer fabric, including all values or ranges derivable therefrom and a combination of at least two features selected from anti-microbial, antistatic, anti-odour, wicking, thermal cooling and ultraviolet protection.

In some embodiments, the graphene incorporated polymer fibre/fabric of the present disclosure comprises graphene and/or its derivatives at a concentration ranging from about 0.0001% (w/w) to 1% (w/w), or about 1 ppm to about 10000 ppm with respect to the weight of the polymer fabric, including all values or ranges derivable therefrom and a combination of at least three features selected from anti-microbial, antistatic, anti-odour, wicking, thermal cooling and ultraviolet protection features.

In some embodiments, the graphene incorporated polymer fibre/fabric of the present disclosure comprises graphene and/or its derivatives at a concentration ranging from about 0.0001% (w/w) to 1% (w/w), or about 1 ppm to about 10000 ppm with respect to the weight of the polymer fabric, including all values or ranges derivable therefrom and a combination of at least four features selected from anti-microbial, antistatic, anti-odour, wicking, thermal cooling and ultraviolet protection features.

In some embodiments, the graphene incorporated polymer fibre/fabric of the present disclosure comprises graphene and/or its derivatives at a concentration ranging from about 0.0001% (w/w) to 1% (w/w), or about 1 ppm to about 10000 ppm with respect to the weight of the polymer fabric, including all values or ranges derivable therefrom and a combination of at least five features selected from anti-microbial, antistatic, anti-odour, wicking, thermal cooling and ultraviolet protection features.

In some embodiments, the graphene incorporated polymer fibre/fabric of the present disclosure comprises graphene and/or its derivatives at a concentration ranging from about 0.0001% (w/w) to 1% (w/w), or about 1 ppm to about 10000 ppm with respect to the weight of the polymer fabric, including all values or ranges derivable therefrom and a combination of anti-microbial, antistatic, anti-odour, wicking, thermal cooling and ultraviolet protection features.

In some embodiments, the present disclosure provides a polymer fibre/fabric comprising graphene and having one or more features selected from the combinations indicated in Table 1. In Table 1, X represents presence of the feature as part of the combination encompassed in each row. Accordingly, every single combination provided in Table 1 represents a separate embodiment of the present disclosure. However, the present disclosure also envisages a merger or mixture of these embodiments to provide for further possible combinations. Thus, for the purposes of the present disclosure, each of the combinations that are derivable from Table 1 below are envisaged to exist individually, all together or in different combinations within the ambit of the present disclosure.

TABLE 1

| | Graphene at | | | | | | |
|---|---|---|---|---|---|---|---|
| | an amount | | | | | | |
| | ranging | | | | | | |
| | from about | | | | | | |
| | 0.0001% | | | | | | |
| | (w/w) to | | | | | | |
| | 1% (w/w), or | | | | | | |
| | about 1 ppm | | | | | | |
| Polymer | to about | Anti- | | Anti- | | Thermal | Ultraviolet |
| fabric/fibre | 10000 ppm | microbial | Antistatic | odour | Wicking | cooling | protection |
| Polymer | X | X | X | X | | | |
| fabric A | | | | | | | |
| Polymer | X | X | X | | X | | |
| fabric B | | | | | | | |
| Polymer | X | X | X | | | X | |
| fabric C | | | | | | | |
| Polymer | X | X | X | | | | X |
| fabric D | | | | | | | |
| Polymer | X | X | | X | X | | |
| fabric E | | | | | | | |
| Polymer | X | X | | X | | X | |
| fabric F | | | | | | | |
| Polymer | X | X | | X | | | X |
| fabric G | | | | | | | |
| Polymer | X | X | | | X | X | |
| fabric H | | | | | | | |
| Polymer | X | X | | | X | | X |
| fabric I | | | | | | | |
| Polymer | X | X | | | | X | X |
| fabric J | | | | | | | |
| Polymer | X | X | X | X | X | | |
| fabric K | | | | | | | |
| Polymer | X | X | X | X | | X | |
| fabric L | | | | | | | |
| Polymer | X | X | X | X | | | X |
| fabric M | | | | | | | |
| Polymer | X | X | X | | X | X | |
| fabric N | | | | | | | |
| Polymer | X | X | X | | X | | X |
| fabric O | | | | | | | |
| Polymer | X | X | | X | X | X | |
| fabric P | | | | | | | |
| Polymer | X | X | | X | X | | X |
| fabric Q | | | | | | | |
| Polymer | X | X | | X | | X | X |
| fabric R | | | | | | | |
| Polymer | X | X | X | | | X | X |
| fabric S | | | | | | | |
| Polymer | X | X | | | X | X | X |
| fabric T | | | | | | | |
| Polymer | X | | X | X | X | X | |
| fabric U | | | | | | | |
| Polymer | X | | X | X | X | | X |
| fabric V | | | | | | | |
| Polymer | X | | X | X | | X | X |
| fabric W | | | | | | | |
| Polymer | X | | | X | X | X | X |
| fabric X | | | | | | | |
| Polymer | X | X | X | X | X | X | |
| fabric Y | | | | | | | |
| Polymer | X | | X | X | X | X | X |
| fabric Z | | | | | | | |
| Polymer | X | X | | X | X | X | X |
| fabric A′ | | | | | | | |
| Polymer | X | X | X | | X | X | X |
| fabric B′ | | | | | | | |
| Polymer | X | X | X | X | | X | X |
| fabric C′ | | | | | | | |
| Polymer | X | X | X | X | X | | X |
| fabric D′ | | | | | | | |
| Polymer | X | X | X | X | X | X | X |
| fabric E′ | | | | | | | |
| Polymer | X | X | | | | | |
| fabric F′ | | | | | | | |
| Polymer | X | | X | | | | |
| fabric G′ | | | | | | | |
| Polymer | X | | | X | | | |
| fabric H′ | | | | | | | |
| Polymer | X | | | | X | | |
| fabric I′ | | | | | | | |
| Polymer | X | | | | | X | |
| fabric J′ | | | | | | | |
| Polymer | X | | | | | | X |
| fabric K′ | | | | | | | |
| Polymer | X | X | X | | | | |
| fabric L′ | | | | | | | |
| Polymer | X | X | | X | | | |
| fabric M′ | | | | | | | |
| Polymer | X | X | | | X | | |
| fabric N′ | | | | | | | |
| Polymer | X | X | | | | X | |
| fabric O′ | | | | | | | |
| Polymer | X | X | | | | | X |
| fabric P′ | | | | | | | |
| Polymer | X | | X | X | | | |
| fabric R′ | | | | | | | |
| Polymer | X | | X | | X | | |
| fabric S′ | | | | | | | |
| Polymer | X | | X | | | X | |
| fabric T′ | | | | | | | |
| Polymer | X | | X | | | | X |
| fabric U′ | | | | | | | |
| Polymer | X | | | X | X | | |
| fabric W′ | | | | | | | |
| Polymer | X | | | X | | X | |
| fabric X′ | | | | | | | |
| Polymer | X | | | X | | | X |
| fabric Y′ | | | | | | | |
| Polymer | X | | | | X | X | |
| fabric Z′ | | | | | | | |
| Polymer | X | | | | X | | X |
| fabric A″ | | | | | | | |
| Polymer | X | | | | | X | X |
| fabric B″ | | | | | | | |
| Polymer | X | | X | X | X | | |
| fabric C″ | | | | | | | |
| Polymer | X | | X | X | | X | |
| fabric D″ | | | | | | | |
| Polymer | X | | X | X | | | X |
| fabric E″ | | | | | | | |
| Polymer | X | | X | | X | X | |
| fabric F″ | | | | | | | |
| Polymer | X | | X | | X | | X |
| fabric G″ | | | | | | | |
| Polymer | X | | X | | | X | X |
| fabric H″ | | | | | | | |
| Polymer | X | | | X | X | X | |
| fabric I″ | | | | | | | |
| Polymer | X | | | X | | X | X |
| fabric J″ | | | | | | | |
| Polymer | X | | | X | X | | X |
| fabric K″ | | | | | | | |
| Polymer | X | | | | X | X | X |
| fabric L″ | | | | | | | |

As can be observed from the above, the concentration of graphene contained in the polymer fibre/fabric remaining between 0.0001% (w/w) to 1% (w/w), or about 1 ppm to about 10000 ppm, the further features of the polymer fibre/fabric may vary with the restriction that any one feature or combination of features selected from anti-microbial, antistatic, anti-odour, wicking, thermal cooling and ultraviolet protection are met. Each of the above fabric is further characterized by features such as but not limited to good/excellent washing fastness, rubbing fastness, perspiration fastness, sublimation fastness and light fastness.

In some embodiments, the graphene containing polymer fibre/fabric of the present disclosure is characterized by an increase of anti-microbial, antistatic, anti-odour, wicking, thermal cooling and ultraviolet protection when compared to a polymer fabric lacking graphene.

In some embodiments, the graphene containing polymer fibre/fabric of the present disclosure is characterized by an increase of at least about 10% of anti-microbial, antistatic, anti-odour, wicking, thermal cooling and ultraviolet protection when compared to a polymer fabric lacking graphene.

Accordingly, the graphene containing polymer fibre/fabric of the present disclosure is characterized by one or more of the following
about 1 fold to about 10 fold increase in anti-microbial activity;
about 1 fold to about 10 increase in antistatic activity;
about 1 fold to about 10 increase in anti-odour activity;
about 10% to about 200% increase in thermal cooling; and
about 10% to about 60% increase in ultraviolet protection,
when compared to a polymer fabric lacking graphene.

In some embodiments, the graphene containing polymer fabric of the present disclosure is characterized by an increase of about 1 fold, about 2 fold, about 3 fold, about 4 fold, about 5 fold, about 6 fold, about 7 fold, about 8 fold, about 9 fold or about 10 fold in anti-microbial properties when compared to a polymer fabric lacking graphene.

In some embodiments, the anti-microbial activity comprises bactericidal or antibacterial effect, bacteriostatic effect, antiviral effect, antifungal effect or combinations thereof. In some embodiments, the polymer fibre/fabric is characterized by a bactericidal effect ranging from about 90% to 99.999%, including all values or ranges derivable therefrom, against Staphylococcus aureus, Klebsiella pneumonia, and Escherichia coli.

In exemplary embodiments, the polymer fibre/fabric is characterized by a bactericidal effect ranging from about 99.94% to 99.95%, including all values or ranges derivable therefrom, against Staphylococcus aureus, Klebsiella pneumonia, and Escherichia coli.

In some embodiments, the polymer fibre/fabric is characterized by a bacteriostatic effect ranging from about 90% to 99.999%, including all values or ranges derivable therefrom, against Staphylococcus aureus, Klebsiella pneumonia, and Escherichia coli.

In some embodiments, the polymer fibre/fabric is characterized by a bacteriostatic effect ranging from about 99% to 99.999%, including all values or ranges derivable therefrom, against Staphylococcus aureus, Klebsiella pneumonia, and Escherichia coli.

In some embodiments, the polymer fibe/fabric is characterized by a bacteriostatic effect comprising log reduction of bacterial value ranging from about 3 to 5, including all values or ranges derivable therefrom, against Staphylococcus aureus, Klebsiella pneumonia, and Escherichia coli. In exemplary embodiments, the polymer fabric is characterized by a bacteriostatic effect comprising log reduction of bacterial value ranging from about 3.25 to 4.22, against Staphylococcus aureus, Klebsiella pneumonia, and Escherichia coli.

In some embodiments, the polymer fibre/fabric is characterized by an antiviral effect ranging from about 90% to 99.999%, including all values or ranges derivable therefrom, against M2 bacteriophage.

In some embodiments, the polymer fibre/fabric is characterized by an antiviral effect ranging from about 99.9% to 99.999%, including all values or ranges derivable therefrom, against M2 bacteriophage.

In some embodiments, the polymer fibre/fabric is characterized by an antiviral effect comprising a log reduction of virus value ranging from about 3 to 4 against M2 bacteriophage. In exemplary embodiments, the polymer fabric is characterized by an antiviral effect comprising a log reduction of virus value ranging from about 3.66 to 3.93 against M2 bacteriophage.

In some embodiments, the polymer fibre/fabric is characterized by an antifungal effect ranging from about 90% to 99.999%, including all values or ranges derivable therefrom, against Aspergillus niger and Candida albicans.

In exemplary embodiments, the polymer fibre/fabric is characterized by an antifungal effect ranging from about 99.70% to 99.99% against Aspergillus niger and Candida albicans.

In some embodiments, the polymer fibre/fabric is characterized by antistatic effect measured by half decay time for discharge of charge applied on the polymer fabric surface which ranges from about 0.1 seconds to 3 seconds, including all values or ranges derivable therefrom. In some embodiments, the static discharge half decay time of the graphene incorporated polymer fabric at a temperature of about 25° C. and at about 45% relative humidity ranges from about 0.5 seconds to 3 seconds.

In some embodiments, the polymer fibre/fabric is characterized by anti-odour effect measured by AATCC 100 standard which ranges from about 90% to 99.999%, including all values or ranges derivable therefrom.

In some embodiments, the polymer fabric is characterized by wicking effect measured by AATCC 197:2013 standard which ranges from about 2 inches/3 minutes to about 5 inches/30 minutes, including all values or ranges derivable therefrom.

In some embodiments, the polymer fabric is characterized by wicking effect measured by AATCC 197:2013 standard having an average vertical moisture wicking height ranging from about 85 to 110 for 30 mins (warp) and average vertical moisture wicking height ranging from about 75 to 90 for 30 mins (weft).

In some embodiments, the polymer fabric is characterized by thermal cooling measured by Q-Max (Qₘₐₓ) which ranges from about 0.1 watts per square centimeter (W/cm²) to 0.7 W/cm², including all values or ranges derivable therefrom.

In some embodiments, the polymer fabric is characterized by ultraviolet protection measured by ultraviolet protection factor (UPF) which ranges from about 200 to 300, including all values or ranges derivable therefrom.

In some embodiments, the polymer fabric of the present disclosure has water absorbency of about 0.1 seconds to about 5 seconds, including all values or ranges derivable therefrom.

In some embodiments, the polymer fabric of the present disclosure has water absorbency of about 2.5 seconds.

In some embodiments, the antimicrobial, antistatic, anti-odour, wicking, thermal cooling and ultraviolet protection features of the polymer fabric of the present disclosure are permanent up to the life of the fibre.

In some embodiments, the anti-microbial, antistatic, anti-odour, wicking, thermal cooling and ultraviolet protection features of the polymer fabric of the present disclosure are maintained up to 20 washes and more.

In some embodiments, the anti-microbial, antistatic, anti-odour, wicking, thermal cooling and ultraviolet protection features of the polymer fabric of the present disclosure are maintained after 30 washes or more.

In some embodiments, the anti-microbial, antistatic, anti-odour, wicking, thermal cooling and ultraviolet protection features of the polymer fabric of the present disclosure are maintained even after at least 50 washes of the polymer fabric.

In some embodiments, the present disclosure achieves the antimicrobial, antistatic, anti-odour, wicking, thermal cooling and ultraviolet protection features of the polymer fabric without compromising the hand-feel, texture and visual aspects of the final fabric.

In some embodiments of the present disclosure, the graphene incorporated polymer fabric comprises graphene and/or its derivatives at a concentration ranging from about 0.0001% (w/w) to 0.2% (w/w). In some embodiments of the present disclosure, the graphene incorporated polymer fabric comprises graphene and/or its derivatives at a concentration ranging from about 0.001% (w/w) to 0.2% (w/w) (w/w). In some embodiments of the present disclosure, the graphene incorporated polymer fabric comprises graphene and/or its derivatives at a concentration ranging from about 0.01% (w/w) to 0.2% (w/w) (w/w). In some embodiments of the present disclosure, the graphene incorporated polymer fabric comprises graphene and/or its derivatives at a concentration ranging from about 0.1% (w/w) to 0.2% (w/w) (w/w). In exemplary embodiments of the present disclosure, the graphene incorporated polymer fabric comprises graphene and/or its derivatives at a concentration of about 0.01% (w/w) to about 0.05% (w/w). In another exemplary embodiment, the graphene incorporated polymer fabric comprises graphene and/or its derivatives at a concentration of about 0.02% (w/w) to about 0.025% (w/w).

In a non-limiting embodiment, the graphene incorporated polymer fabric comprises graphene and/or its derivatives at a concentration of about 0.0001% (w/w), about 0.00015%(w/w), about 0.0002%(w/w), about 0.00025%(w/w), about 0.0003%(w/w), about 0.00035%(w/w), about 0.0004%(w/w), about 0.00045%(w/w), about 0.0005%(w/w), about 0.00055%(w/w), about 0.0006%(w/w), about 0.00065%(w/w), about 0.0007%(w/w), about 0.00075%(w/w), about 0.0008%(w/w), about 0.00085%(w/w), about 0.0009%(w/w), about 0.00095%(w/w), about 0.001%(w/w), about 0.0015%(w/w), about 0.002%(w/w), about 0.0025%(w/w), about 0.003%(w/w), about 0.0035%(w/w), about 0.004%(w/w), about 0.0045%(w/w), about 0.005%(w/w), about 0.0055%(w/w), about 0.006%(w/w), about 0.0065%(w/w), about 0.007%(w/w), about 0.0075%(w/w), about 0.008%(w/w), about 0.0085%(w/w), about 0.009%(w/w), about 0.0095%(w/w), about 0.01%(w/w), about 0.015%(w/w), about 0.02%(w/w), about 0.025%(w/w), about 0.03%(w/w), about 0.035%(w/w), about 0.04%(w/w), about 0.045%(w/w), about 0.05%(w/w), about 0.055%(w/w), about 0.06%(w/w), about 0.065%(w/w), about 0.07%(w/w), about 0.075%(w/w), about 0.08%(w/w), about 0.085%(w/w), about 0.09%(w/w), about 0.095%(w/w), about 0.1%(w/w), about 0.15%(w/w), about 0.2%(w/w), about 0.25%(w/w), about 0.3%(w/w), about 0.35%(w/w), about 0.40%(w/w), about 0.45%(w/w), about 0.5%(w/w), about 0.55%(w/w), about 0.6%(w/w), about 0.65%(w/w), about 0.7%(w/w), about 0.75%(w/w), about 0.8%(w/w), about 0.85%, about 0.9%(w/w), about 0.95%(w/w) or about 1%(w/w), including all values therein between.

In some embodiments, the graphene incorporated polymer fabric comprises graphene and/or its derivatives at a concentration ranging from about 0.0001% (w/w) to less than 0.005% (w/w).

In some embodiments, the graphene incorporated polymer fabric comprises graphene and/or its derivatives at a concentration ranging from about 0.0001% (w/w) to 0.004% (w/w).

In some embodiments of the present disclosure, the graphene incorporated polymer fabric comprises graphene and/or its derivatives at an amount ranging from about 1 ppm to 1000 ppm. In some embodiments of the present disclosure, the graphene incorporated polymer fabric comprises graphene and/or its derivatives at an amount ranging from about 10 ppm to 500 ppm. In some embodiments of the present disclosure, the graphene incorporated polymer fabric comprises graphene and/or its derivatives at an amount ranging from about 50 ppm to 500 ppm. In some embodiments of the present disclosure, the graphene incorporated polymer fabric comprises graphene and/or its derivatives at an amount ranging from about 100 ppm to 500 ppm. In exemplary embodiments of the present disclosure, the graphene incorporated polymer fabric comprises graphene and/or its derivatives at an amount ranging from about 150 ppm to 500 ppm. In another exemplary embodiment, the graphene incorporated polymer fabric comprises graphene and/or its derivatives at an amount ranging from about 50 ppm to 300 ppm. In another exemplary embodiment, the graphene incorporated polymer fabric comprises graphene and/or its derivatives at an amount ranging from about 50 ppm to 200 ppm.

In a non-limiting embodiment, the graphene incorporated polymer fabric comprises graphene and/or its derivatives at an amount of about 1 ppm, 10 ppm, 20 ppm, 30 ppm, 40 ppm, 50 ppm, 60 ppm, 70 ppm, 80 ppm, 90 ppm, 100 ppm, 110 ppm, 120 ppm, 130 ppm, 140 ppm, 150 ppm, 160 ppm, 170 ppm, 180 ppm, 190 ppm, 200 ppm, 210 ppm, 220 ppm, 230 ppm, 240 ppm, 250 ppm, 260 ppm, 270 ppm, 280 ppm, 290 ppm, 300 ppm, 310 ppm, 320 ppm, 330 ppm, 340 ppm, 350 ppm, 360 ppm, 370 ppm, 380 ppm, 390 ppm, 400 ppm, 410 ppm, 420 ppm, 430 ppm, 440 ppm, 450 ppm, 460 ppm, 470 ppm, 480 ppm, 490 ppm, 500 ppm, 510 ppm, 520 ppm, 530 ppm, 540 ppm, 550 ppm, 560 ppm, 570 ppm, 580 ppm, 590 ppm, 600 ppm, 610 ppm, 620 ppm, 630 ppm, 640 ppm, 650 ppm, 660 ppm, 670 ppm, 680 ppm, 690 ppm, 700 ppm, 710 ppm, 720 ppm, 730 ppm, 740 ppm, 750 ppm, 760 ppm, 770 ppm, 780 ppm, 790 ppm, 800 ppm, 810 ppm, 820 ppm, 830 ppm, 840 ppm, 850 ppm, 860 ppm, 870 ppm, 880 ppm, 890 ppm, 900 ppm, 910 ppm, 920 ppm, 930 ppm, 940 ppm, 950 ppm, 960 ppm, 970 ppm, 980 ppm, 990 ppm, 1000 ppm, 2000 ppm, 3000 ppm, 4000 ppm, 5000 ppm, 6000 ppm, 7000 ppm, 8000 ppm, 9000 ppm or about 10000 ppm, including all values therein between.

In some embodiments, the graphene incorporated polymer fabric comprises graphene and/or its derivatives at an amount of about 50 ppm.

In some embodiments, the graphene incorporated polymer fabric comprises graphene and/or its derivatives at an amount of about 100 ppm.

In some embodiments, the graphene incorporated polymer fabric comprises graphene and/or its derivatives at an amount of about 150 ppm.

In some embodiments, the graphene incorporated polymer fabric comprises graphene and/or its derivatives at an amount of about 200 ppm.

Thus, in some embodiments, the graphene incorporated polymer fibre/fabric of the present disclosure comprises graphene and/or its derivatives at an amount of about 50 ppm with respect to the weight of the polymer fabric and any combination of features selected from a group comprising anti-microbial, antistatic, anti-odour, wicking, thermal cooling and ultraviolet protection features.

Similarly, in some embodiments, the graphene incorporated polymer fibre/fabric of the present disclosure comprises graphene and/or its derivatives at an amount of about 100 ppm with respect to the weight of the polymer fabric and any combination of features selected from a group comprising anti-microbial, antistatic, anti-odour, wicking, thermal cooling and ultraviolet protection features.

Further, in some embodiments, the graphene incorporated polymer fibre/fabric of the present disclosure comprises graphene and/or its derivatives at an amount of about 150 ppm with respect to the weight of the polymer fabric and any combination of features selected from a group comprising anti-microbial, antistatic, anti-odour, wicking, thermal cooling and ultraviolet protection features.

Furthermore, in some embodiments, the graphene incorporated polymer fibre/fabric of the present disclosure comprises graphene and/or its derivatives at an amount of about 200 ppm with respect to the weight of the polymer fabric and any combination of features selected from a group comprising anti-microbial, antistatic, anti-odour, wicking, thermal cooling and ultraviolet protection features.

In some embodiments, the graphene incorporated polymer fibre/fabric of the present disclosure comprises graphene and/or its derivatives at an amount of about 50 ppm, 100 ppm, 150 ppm or 200 ppm with respect to the weight of the polymer fabric and a combination of anti-microbial, wicking, thermal cooling and ultraviolet protection features.

In embodiments of the present disclosure, the graphene derivatives are selected from a group comprising graphene nanoplatelets, graphene oxides, reduced graphene oxides, functionalized graphene, graphene decorated with metal particles, nanosized graphene, graphene quantum dots, any graphene containing material, and combinations thereof. However, any derivative of graphene must in-turn be a combination of single and multi-layered graphene derivative, and comprise about 80% to about 85% of single layered graphene derivative, and about 15% to about 20% multi-layered graphene derivative, wherein the multi-layered graphene derivative is made up of about 2 to about 5 layers of graphene.

In some embodiments, the graphene employed to prepare the graphene incorporated fabric of the present disclosure is a combination of single and multi-layered graphene, and comprises about 80% to about 85% of single layered graphene, and about 15% to about 20% multi-layered graphene, wherein the multi-layered graphene is made up of about 2 to about 5 layers of graphene; and collectively referred to as ‘multi-layered graphene’.

Further, as also mentioned previously, the graphene employed herein is preferably of high surface area, typically ranging between 100 m²/g to 2000 m²/g, more typically between 300 m²/g to 800 m²/g. In non-limiting embodiments, the surface area of graphene incorporated into the polymer fabric of the present disclosure is about 100 m²/g, about 200 m²/g, 300 m²/g, 400 m²/g, 500 m²/g, 600 m²/g, 700 m²/g, 800 m²/g, 900 m²/g, 1000 m²/g, 1100 m²/g, 1200 m²/g, 1300 m²/g, 1400 m²/g, 1500 m²/g, 1600 m²/g, 1700 m²/g, 1800 m²/g, 1900 m²/g or 2000 m²/g.

Accordingly, in some embodiments, the graphene incorporated polymer fibre/fabric of the present disclosure comprises multi-layered graphene and/or its derivatives at an amount ranging from about 1 ppm to 10000 ppm with respect to the weight of the polymer fabric and any combination of features selected from a group comprising anti-microbial, antistatic, anti-odour, wicking, thermal cooling and ultraviolet protection features.

In some embodiments, the graphene incorporated polymer fibre/fabric of the present disclosure comprises multi-layered graphene and/or its derivatives at an amount of about 50 ppm with respect to the weight of the polymer fabric and any combination of features selected from a group comprising anti-microbial, antistatic, anti-odour, wicking, thermal cooling and ultraviolet protection features.

In some embodiments, the graphene incorporated polymer fibre/fabric of the present disclosure comprises multi-layered graphene and/or its derivatives at an amount of about 100 ppm with respect to the weight of the polymer fabric and any combination of features selected from a group comprising anti-microbial, antistatic, anti-odour, wicking, thermal cooling and ultraviolet protection features.

In some embodiments, the graphene incorporated polymer fibre/fabric of the present disclosure comprises multi-layered graphene and/or its derivatives at an amount of about 150 ppm with respect to the weight of the polymer fabric and any combination of features selected from a group comprising anti-microbial, antistatic, anti-odour, wicking, thermal cooling and ultraviolet protection features.

In some embodiments, the graphene incorporated polymer fibre/fabric of the present disclosure comprises multi-layered graphene and/or its derivatives at an amount of about 200 ppm with respect to the weight of the polymer fabric and any combination of features selected from a group comprising anti-microbial, antistatic, anti-odour, wicking, thermal cooling and ultraviolet protection features.

In some embodiments, the graphene incorporated polymer fibre/fabric of the present disclosure comprises multi-layered graphene and/or its derivatives at an amount of about 50 ppm, 100 ppm, 150 ppm or 200 ppm with respect to the weight of the polymer fabric and a combination of anti-microbial, wicking, thermal cooling and ultraviolet protection features.

In some embodiments, the graphene employed to prepare the graphene incorporated fabric of the present disclosure is a multi-layered graphene, having surface area ranging from about 300 m²/g to about 800 m²/g, or about 400 m²/g to about 500 m²/g.

As mentioned previously, in each of the above embodiments, the graphene containing polymer fibre/fabric of the present disclosure is characterized by one or more of the following
about 1 fold to about 10 fold increase in anti-microbial activity;
about 10% to about 200% increase in thermal cooling; and
about 10% to about 60% increase in ultraviolet protection,
when compared to a polymer fabric lacking graphene.

In embodiments of the present disclosure, the graphene incorporated polymer fabric product is a dyed polymer fabric product obtained after subjecting the polymer fabric to dyeing technique(s) in presence of graphene and/or derivative(s) thereof. Accordingly, the graphene incorporated polymer fabric product of the present disclosure may further comprise dyeing/coating agents or components.

In embodiments of the present disclosure, the polymer is selected from a group comprising natural polymer, synthetic polymer, blend of natural polymer and synthetic polymer, and combinations thereof. Thus, the polymer employed in the present disclosure is any polymer that is capable of being formed into a fibre. Thus, the polymer employed in the present disclosure is a fibre forming polymer.

In embodiments of the present disclosure, the natural polymer is selected in a manner that results in fabric selected from a group comprising polymer fabric derived from Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein and combinations thereof.

In embodiments of the present disclosure, the synthetic polymer is selected in a manner that results in fabric selected from a group comprising Acetate, Acrylic, Lyocell, Modacrylic, Microfibre, Nomex, Nylon, Polyester, Polypropylene, Polyvinyl chloride, Rayon/Viscose, Spandex, Kevlar and combinations thereof.

In embodiments of the present disclosure, the blended polymer is selected in a manner that results in fabric derived from any combination of materials selected from a group comprising Alpaca, Angora wool, Azlon, Byssus, Camel hair, Cashmere wool, Chiengora, Lambswool, Llama, Mohair wool, Qiviut, Rabbit, Silk, Vicuña, Wool, Yak, Abacá, Acetate, Bamboo, Banana, Kapok, Coir, Cotton, Flax, Hemp, Jute, Kenaf, Lyocell, Modal, Piña, Raffia, Ramie, Rayon, Sisal, Soy protein, Acetate, Acrylic, Lyocell, Modacrylic, Microfibre, Nomex, Nylon, Polyester, Polypropylene, Polyvinyl chloride, Rayon/Viscose, Spandex and Kevlar.

In some embodiments, the graphene containing polymer fabric of the present disclosure is a graphene containing polyester fabric, in turn composed of fibre or yarn that is made of polyester. As is commonly understood, polyester is a category of polymers that contain the ester functional group in every repeat unit of their main chain. In some embodiments, polyester refers to polyethylene terephthalate (PET), formed of monomer ethylene terephthalate. In some embodiments, the said monomer ethylene terephthalate in in-turn prepared from transesterification reaction between ethylene glycol and dimethyl terephthalate (DMT) or esterification reaction between ethylene glycol and terephthalic acid.

In some embodiments, the polyethylene terephthalate (PET) is prepared from a single species of monomers or multiple species of monomers. Accordingly, in an embodiment, the PET is prepared solely from monomer ethylene terephthalate, or is prepared by a combination of ethylene terephthalate and isophthalic acid. In either case, the ethylene terephthalate is obtained by esterification reaction between terephthalic acid (PTA) and ethylene glycol, such as mono ethylene glycol (MEG).

Accordingly, in some embodiments, the graphene incorporated polymer fibre/fabric of the present disclosure comprises multi-layered graphene and/or its derivatives at an amount ranging from about 1 ppm to 10000 ppm with respect to the weight of the polymer fabric and any combination of features selected from a group comprising anti-microbial, antistatic, anti-odour, wicking, thermal cooling and ultraviolet protection features, wherein the polymer fibre/fabric is a polyester fibre/fabric.

In some embodiments, the graphene incorporated polymer fibre/fabric of the present disclosure comprises multi-layered graphene and/or its derivatives at an amount of about 50 ppm with respect to the weight of the polymer fabric and any combination of features selected from a group comprising anti-microbial, antistatic, anti-odour, wicking, thermal cooling and ultraviolet protection features, wherein the polymer fibre/fabric is a polyester fibre/fabric.

In some embodiments, the graphene incorporated polymer fibre/fabric of the present disclosure comprises multi-layered graphene and/or its derivatives at an amount of about 100 ppm with respect to the weight of the polymer fabric and any combination of features selected from a group comprising anti-microbial, antistatic, anti-odour, wicking, thermal cooling and ultraviolet protection features, wherein the polymer fibre/fabric is a polyester fibre/fabric.

In some embodiments, the graphene incorporated polymer fibre/fabric of the present disclosure comprises multi-layered graphene and/or its derivatives at an amount of about 150 ppm with respect to the weight of the polymer fabric and any combination of features selected from a group comprising anti-microbial, antistatic, anti-odour, wicking, thermal cooling and ultraviolet protection features, wherein the polymer fibre/fabric is a polyester fibre/fabric.

In some embodiments, the graphene incorporated polymer fibre/fabric of the present disclosure comprises multi-layered graphene and/or its derivatives at an amount of about 200 ppm with respect to the weight of the polymer fabric and any combination of features selected from a group comprising anti-microbial, antistatic, anti-odour, wicking, thermal cooling and ultraviolet protection features, wherein the polymer fibre/fabric is a polyester fibre/fabric.

In some embodiments, the graphene incorporated polymer fibre/fabric of the present disclosure comprises multi-layered graphene and/or its derivatives at an amount of about 50 ppm, 100 ppm, 150 ppm or 200 ppm with respect to the weight of the polymer fabric and a combination of anti-microbial, wicking, thermal cooling and ultraviolet protection features, wherein the polymer fibre/fabric is a polyester fibre/fabric.

In some embodiments, the graphene employed in the present disclosure is a combination of single and multi-layered graphene, and comprises about 80% to about 85% of single layered graphene, and about 15% to about 20% multi-layered graphene, wherein the multi-layered graphene is made up of about 2 to about 5 layers of graphene.

In some embodiments, the graphene is incorporated or infused during synthesis of the polymer, and prior to polymerization of the monomers that form the polymer fibre of the polymer fabric of the present disclosure.

In some embodiments of the present disclosure, the graphene is dispersed in the ethylene glycol using high shear mixer to form a homogeneous slurry, which is further used as a graphene source during synthesis of the polymer, prior to the step of polymerization.

Accordingly, the graphene infused polymer is converted to polymer fibre or filament, for preparing the polymer fabric of the present disclosure.

In embodiments of the present disclosure, graphene which is an atom thick honeycomb lattice of carbon possess extraordinary anti-microbial properties along with mechanical, thermal, electrical properties. Based on the number of stacking of layers in each entity, the graphene is classified as monolayer, bi-layer, tri-layer and multilayer. The physical structure and chemically functionalized groups of the graphene has the ability to kill and control the growth of microorganisms and therefore provides anti-bacterial activity to graphene. The atom thick sheets of carbon have sharp edges and spikes that act as a sharp knife which cause irreversible damages to the cell membranes of the bacteria and kills them. Additionally, in another mechanism, the bacteria/microbes are wrapped by large sheets of graphene and get killed. The functionalized groups of graphene react chemically with the anti-oxidant groups of the bacteria (GSH-glutathione) in the cell membrane that oxidises said anti-oxidant groups of bacteria and induces oxidative stress which kill the bacteria. Accordingly, due to the above mechanisms and the synergetic effect of physical and chemical destructions to the cell membranes of bacteria, graphene acts as a strong antibacterial/anti-microbial agent and provides better/improved antibacterial/anti-microbial activity compared to the currently available anti-microbial agents. Its unique shape, structure, morphology, particle size, aspect ratio and chemical functionalities further make it a multifunctional additive for textile industry.

In addition to the above, the atom thick honey-comb carbon based lattice structure of graphene possesses extraordinary electrical properties due to overlapping of π-orbitals. The in-plane electrical conductivity of monolayer graphene is about 1×10⁻⁶ ohm·cm with an electron mobility of about 200000 cm²/Vs. Based on the number of stacked layers in each entity the graphene is classified as monolayer, bi-layer, tri-layer and multilayer. Coating or infusing graphene in polymer fabrics greatly enhances the electrical conductivity and thus improves the anti-static property of the polymer fabrics. Accordingly, due to the above properties of graphene, graphene is considered to confer to polymer fabrics more efficient and durable anti-static properties as compared to the currently available anti-static agents. In some embodiments, infusion of subtle quantity of graphene into polymer fabrics, for instance from at least about 0.0001 wt % to 1% (w/w), or about 1 ppm to about 10000 ppm of graphene with respect to the weight of the polymer fabric [grams per square metre (GSM) of polymer fabric], particularly a polymer fabric having GSM ranging from about 50 GSM to 500 GSM, effectively reduces resistivity of the polymer fabric from about 1016 ohm·cm to less than about 109 ohm·cm, allowing for quick dissipation of charges from the polymer fabric surface, thus leading to anti-static property of the treated polymer fabric. This helps prevent build-up of static electricity in the polymer fabric and helps overcome triboelectric effect arising from rubbing of the polymer fabric. Anti-static agents typically employed in the art increase the electrical conductivity of the polymer fabric by forming hygroscopic intermediate layers on the polymer fabric surface that absorb moisture and enhance conductivity. However, said absorption of moisture for achieving anti-static effect interferes with properties of the polymer fabric such as wicking and thermal cooling, which are important for breathability of the polymer fabric. Said properties of wicking and thermal cooling are extremely important for the comfort of the wearer especially in the case of garments such as sportswear or uniforms wherein in addition to features such as anti-static and anti-microbial, features such as wicking and thermal cooling of the polymer fabric are also important for purposes of hygiene and comfort. Accordingly, the present disclosure provides a simple yet effective solution to said problem by providing a simple polymer fabric that has all of the aforesaid properties additionally along with UV protection.

The present disclosure further relates to the preparation of the graphene incorporated or infused polymer fibre/fabric. In embodiments of the present disclosure, the production of graphene incorporated polymer fabric comprises incorporating graphene and/or its derivatives in the polymer during its synthesis, and prior to the polymerization process, and drawing the polymer into a fibre optionally followed by converting it to a fabric.

Accordingly, the present disclosure provides a process of preparing a polymer fabric comprising about 0.0001% (w/w) to 1% (w/w), or about 1 ppm to 10000 ppm graphene, said polymer fabric characterized by feature selected from a group comprising anti-microbial, antistatic, anti-odour, wicking, thermal cooling and ultraviolet protection, or any combination thereof, the process comprising incorporating or infusing graphene in a polymer fibre of the polymer fabric.

The process of the present disclosure provides for incorporation of graphene into the polymer through a polymerization-based process that results in a corresponding fibre/fabric that exhibits one or more of the above-mentioned characteristics selected from anti-microbial, antistatic, anti-odour, wicking, thermal cooling and ultraviolet protection.

The graphene so employed in the said process is in a slurry form, particularly as a stable dispersion of graphene in an organic solvent such as but not limited to monoethylene glycol (MEG).

In some embodiments, the graphene so employed in the said process is in slurry form, particularly as a stable dispersion of graphene in an organic solvent such as but not limited to 1,4-butane diol, dimethyl terephthalate, 1,3-propane diol, other appropriate diols, and lactic acid.

In some embodiments, the present disclosure provides a process for preparing the graphene containing polymer fibre, said process comprising step of polymerization of the polymer with the graphene to obtain a graphene incorporated polymer resin, which is drawn into a corresponding fibre or fabric.

In some embodiments, the polymerization is a condensation polymerization.

In some embodiments, the polymerization of the polymer with the graphene to obtain a graphene incorporated polymer comprises steps of:
a) mixing a polymer precursor with an organic solvent to form a polymer precursor slurry;
b) optionally adding a catalyst and/or a contaminant suppressant to the slurry;
c) esterifying the slurry of step (a) or (b) to obtain an esterified mixture;
d) adding a slurry of graphene or its derivative prepared in an organic solvent to the esterified mixture;
e) subjecting the mixture obtained at the end of step (d) to polymerization to prepare the graphene incorporated polymer.

Thereafter, the polymer is drawn into a fibre or fabric to obtain graphene incorporated polymer fibre or fabric.

In some embodiments, the polymer precursor is selected from a group comprising ethylene glycol, terephthalic acid, isophthalic acid, propylene, 1,4-butane diol, dimethyl terephthalate, 1,3-propane diol, other appropriate diols, naphthalene-2,6-dicarboxylic acid, furan dicarboxylic acid and lactic acid, or any combination thereof.

In some embodiments, the organic solvent employed to form the polymer precursor slurry is selected from a group comprising mono ethylene glycol (MEG), propylene glycol, butylene glycol and propylene glycol, or any combination thereof.

Thus, in some embodiments, the polymer precursor comprises ethylene glycol, terephthalic acid, isophthalic acid, and the organic solvent employed to form the polymer precursor slurry is MEG.

In some embodiments, when MEG is employed as an organic solvent for preparing the polymer precursor slurry, and when the polymer to be prepared is PET, the MEG also acts a precursor and provides the necessary monomers for polymerization to prepare the PET.

Accordingly, in some embodiments, the polymerization of the polymer with the graphene to obtain a graphene incorporated polymer comprises steps of:
a) mixing terephthalic acid and isophthalic acid with MEG to form a polymer precursor slurry;
b) optionally adding a catalyst and/or a contaminant suppressant to the slurry;
c) esterifying the slurry of step (a) or (b) to obtain an esterified mixture;
d) adding a slurry of graphene prepared in an organic solvent to the esterified mixture;
e) subjecting the mixture obtained at the end of step (d) to polymerization to prepare the graphene incorporated polymer.

The condensation polymerization process begins by mixing the polymer precursor with the organic solvent (diol) at a specific mole ratio to arrive at a slurry. In some embodiments, the mole ratio of the polymer precursor to the organic solvent ranges from about 1:1.8 to about 1:2.2.

In some embodiments, the mole ratio of the polymer precursor to the organic solvent is about 1:2.

For example, for preparing a batch size of about 55 kg, about 47.3 kg of purified terephthalic acid (PTA) and about 35.5 kg of mono ethylene glycol (MEG) were mixed to prepare a polymer precursor slurry. Accordingly, a person skilled in the art will be fully aware of the exact quantities/amounts of polymer precursor and organic solvent that is to be employed for preparing an appropriate batch size of desired polymer.

As mentioned above, in some embodiments, the polymer precursor slurry also optionally comprises a catalyst and/or a contaminant suppressant.

When present, the catalyst is an antimony, titanium or germanium based catalyst. In some embodiments, the catalyst is antimony trioxide. In some embodiments, the catalyst is germanium dioxide. The amount of the catalyst is chosen such that polymer precursor slurry contains about 30 ppm to about 300 ppm of the catalyst's primary element, such as antimony. In some embodiments, the amount of the catalyst is chosen such that polymer precursor slurry contains about 200 ppm to about 300 of antimony. In some embodiments, the amount of the catalyst is chosen such that polymer precursor slurry contains about 290 ppm of antimony.

Similarly, when present, the contaminant suppressant is an alkali base, such as NaOH. The amount of the suppressant is chosen such that the polymer precursor slurry contains about 10 ppm to about 50 ppm of the alkali metal, such as sodium. In some embodiments, the amount of the suppressant is chosen such that polymer precursor slurry contains about 25 ppm of sodium.

The above steps of addition of reagents to the polymer slurry is followed by carrying out esterification of the reactants in the slurry to obtain an esterified mixture under appropriate conditions of temperature and pressure.

In some embodiments, the esterification is carried out at a temperature ranging from about 240° C. to about 292° C. and at a pressure ranging from about 1 bar to about 5 bar.

In some embodiments, the esterification is carried out at a temperature of about 262° C.

In some embodiments, upon addition of the graphene slurry to the esterified mixture, the two are mixed at a mixing rate of about 100 RPM to 1000 RPM.

Once esterification was completed, the graphene slurry was added to the esterified mixture.

In some embodiments, the graphene slurry is prepared by high shear mixing or by methods such as sonication, hydrodynamic cavitation, and ball milling. Said graphene slurry is prepared in an organic solvent optionally along with a surfactant. Said mixing step is crucial to achieve efficient dispersion of graphene in the slurry to avoid the agglomeration of the graphene in the final product.

In some embodiments, the mixing is carried out for a time period ranging from about 2 hours to about 4 hours. In some embodiments, the mixing is carried out for 3 hours.

In some embodiments, the organic solvent for preparing the graphene slurry is selected from a group comprising mono ethylene glycol (MEG), propylene glycol, 1,3-propane diol, butylene glycol, 1,4-butane diol, dimethyl terephthalate, other appropriate diols and lactic acid, or any combination thereof.

In some embodiments, the organic solvent for preparing the graphene slurry is MEG.

In some embodiments, the surfactant is selected from a group comprising polyvinylpyrrolidone (PVP), sodium dodecyl sulfate (SDS), sodium lauryl sulfate (SLS), Sodium lauryl ether sulfate (SLES), Silicon and combinations thereof.

In some embodiments, ratio between the graphene and the surfactant in the graphene slurry ranges from about 1:280 to 2:1.

In some embodiments, the graphene slurry is prepared in MEG, which is also the monomer used for polymerization to make the polyester PET.

In some embodiments, the graphene and organic solvent is subjected to mixing at a mixing rate of about 100 RPM to 10,000 RPM.

In some embodiments, the graphene slurry also comprises phosphoric acid to provide about 10 ppm of phosphorus along with about 0.25% of TiO₂. This acts as a binder within the slurry.

In some embodiments, the concentration of graphene within the slurry ranges from about 0.0001 wt % to 7 wt %.

In some embodiments, concentration of graphene within the slurry ranges from about 0.01 wt % to 7 wt %.

In some embodiments, concentration of graphene within the slurry ranges from about 1 wt % to 7 wt %.

In some embodiments, concentration of graphene within the slurry ranges from about 1 wt % to 2 wt %.

In some embodiments, concentration of graphene within the slurry ranges from about 0.1 wt % to 0.5 wt %.

In some embodiments, concentration of graphene within the slurry is at about 0.1 wt %, about 0.5%, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt % or about 7 wt %.

In some embodiments, concentration of graphene within the slurry is at about 2 wt %.

In some embodiments, upon addition of graphene to the MEG or any other organic solvent, the viscosity of the solution increases. Because of the nature of graphene, the viscosity increase with 2% is sufficiently high to prepare an optimum slurry for further processing as per the steps of the present dislcosure.

For example, for preparing a graphene slurry of 50 kg, about 1 kg of graphene is dispersed in 49 kg of MEG. Accordingly, a person skilled in the art will be fully aware of the exact quantities/amounts of graphene and organic solvent that is to be employed for preparing a graphene slurry of appropriate concentration.

In some embodiments, the graphene slurry is prepared at a concentration higher than that at which it is present in the final polymer fabric. Once the condensation process is completed, the final polymer fibre or the corresponding fabric comprises graphene at a concentration of about 0.0001 wt % to 1 wt %, or about 1 ppm to about 10000 ppm as defined herein.

Accordingly, the graphene slurry is added to the esterified mixture at an amount such that post the addition, the esterified mixture contains about 1 ppm to about 10000 ppm of graphene.

Thus, in some embodiments, the graphene slurry is added to the esterified mixture at an amount such that post the addition, the esterified mixture contains about 10 ppm to about 1000 ppm of graphene.

In some embodiments, the graphene slurry is added to the esterified mixture at an amount such that post the addition, the esterified mixture contains about 50 ppm to about 500 ppm of graphene.

Further, in some embodiments, the graphene slurry is added to the esterified mixture at an amount such that post the addition, the esterified mixture contains about 50 ppm to about 300 ppm of graphene.

In some embodiments, the graphene slurry is added to the esterified mixture at an amount such that post the addition, the esterified mixture contains about 50 ppm to about 200 ppm of graphene.

The reaction is thereafter subjected to condensation polymerization under fine vacuum at a specific temperature.

In some embodiments, the condensation polymerization is carried out at less that about 0.5 ton, at a temperature of about 290° C. Since condensation polymerization is a well-known process, the conditions at which it is carried out is well known and understood to a person skilled in the art. As would be apparent, the conditions could vary depending on the components of the process, and all such variations are within the ambit of the present disclosure.

In some embodiments, after achieving desired characteristics, the polymerized material i.e. the graphene incorporated polymer is taken out. The polymerized material resulting from the condensation polymerization process is a graphene incorporated polymer.

In some embodiments the graphene incorporated polymer is drawn into a fibre, and subsequently employed to prepare a fabric.

In some embodiments, the process of preparing the graphene incorporated polymer fibre/fabric of the present disclosure comprises:
a) preparing the graphene slurry;
b) mixing the graphene slurry with an esterified mixture of polymer precursors;
c) subjecting the mixture to polymerization to prepare the graphene incorporated polymer, followed by drawing the polymer into a fibre, wherein the fibre contains graphene at an amount ranging from about 0.0001% (w/w) to 1% (w/w) or about 1 ppm to about 10000 ppm, and said polymer fibre and the corresponding fabric characterized by feature selected from a group comprising anti-microbial, antistatic, anti-odour, wicking, thermal cooling and ultraviolet protection, or any combination thereof.

In all embodiments of the process for preparing the graphene incorporated or infused polymer fibre or fabric, all aspects related to the graphene and the polymers are as described by any of the embodiments above, that described the prepared polymer fibre/fabric itself. For the sake of brevity, and avoiding repetition, each of those embodiments are not being reiterated here again. However, each of the said embodiments pertaining to the type and amount of graphene and/or polymers, completely fall within the purview of the process for preparing the said polymer fibre or fabric.

Thus, in some embodiments, the graphene employed during the process for preparing the graphene infused polymer includes graphene derivatives selected from a group comprising graphene nanoplatelets, graphene oxides, reduced graphene oxides, functionalized graphene, graphene decorated with metal particles, nanosized graphene, graphene quantum dots, any graphene containing material, and combinations thereof.

In some embodiments, the graphene employed in the process to prepare the graphene incorporated fibre or fabric of the present disclosure is a multi-layered graphene.

Further, as also mentioned previously, the graphene employed in the process to prepare the graphene incorporated fibre or fabric of the present disclosure is preferably of high surface area, typically ranging between 100 m²/g to 2000 m²/g, more typically between 300 m²/g to 800 m²/g. In non-limiting embodiments, the surface area of graphene incorporated into the polymer fabric of the present disclosure is about 100 m²/g, about 200 m²/g, 300 m²/g, 400 m²/g, 500 m²/g, 600 m²/g, 700 m²/g, 800 m²/g, 900 m²/g, 1000 m²/g, 1100 m²/g, 1200 m²/g, 1300 m²/g, 1400 m²/g, 1500 m²/g, 1600 m²/g, 1700 m²/g, 1800 m²/g, 1900 m²/g or 2000 m²/g.

In some embodiments, the graphene employed in the process to prepare the graphene incorporated fibre or fabric of the present disclosure is a multi-layered graphene, having surface area ranging from about 300 m²/g to about 800 m²/g, or about 400 m²/g to about 500 m²/g. As mentioned above, the said graphene is a combination of single and multi-layered graphene, and comprises about 80% to about 85% of single layered graphene, and about 15% to about 20% multi-layered graphene, wherein the multi-layered graphene is made up of about 2 to about 5 layers of graphene.

In some embodiments, the polymer employed in the process to prepare the graphene incorporated fibre or fabric of the present disclosure is selected from a group comprising natural polymer, synthetic polymer, blend of natural polymer and synthetic polymer, and combinations thereof. Thus, the polymer employed in the present disclosure is any polymer that is capable of being formed into a fibre. Thus, the polymer employed in the present disclosure is a fibre forming polymer.

In some embodiments, the polymer employed in the process to prepare the graphene incorporated fibre or fabric of the present disclosure is a polyester, such as PET.

Accordingly, in some embodiments, the polymerization of the polymer with the graphene to obtain a graphene incorporated polymer comprises steps of:
a) mixing a polyester precursor with an organic solvent to form a polyester precursor slurry;
b) optionally adding a catalyst such as antimony trioxide and/or a contaminant suppressant such as NaOH to the slurry;
c) esterifying the slurry of step (a) or (b) to obtain an esterified mixture;
d) adding a slurry of multi-layered graphene prepared in MEG and surfactant to the esterified mixture;
e) subjecting the mixture obtained at the end of step (d) to condensation polymerization to prepare the graphene incorporated polymer, having about 1 ppm to about 10000 ppm of graphene.

Further, in some embodiments, the polymerization of the polymer with the graphene to obtain a graphene incorporated polymer comprises steps of:
a) mixing terephthalic acid with MEG to form a polyester precursor slurry;
b) optionally adding a catalyst such as antimony trioxide and/or a contaminant suppressant such as NaOH to the slurry;
c) esterifying the slurry of step (a) or (b) to obtain an esterified mixture;
d) adding a slurry of multi-layered graphene prepared in MEG and surfactant to the esterified mixture;
e) subjecting the mixture obtained at the end of step (d) to condensation polymerization to prepare the graphene incorporated polymer, having about 1 ppm to about 10000 ppm of graphene.

Similarly, in some embodiments, the polymerization of the polymer with the graphene to obtain a graphene incorporated polymer comprises steps of:
a) mixing terephthalic acid and isophthalic acid with MEG to form a polyester precursor slurry;
b) adding a catalyst such as antimony trioxide and a contaminant suppressant such as NaOH to the slurry;
c) esterifying the slurry of step (b) to obtain an esterified mixture;
d) adding a slurry of multi-layered graphene prepared in MEG and surfactant to the esterified mixture;
e) subjecting the mixture obtained at the end of step (d) to condensation polymerization to prepare the graphene incorporated polymer, having about 50 ppm to about 500 ppm of graphene.

In some embodiments, post preparation of the graphene incorporated polymer, the polymer is then dried, and converted appropriately into a filament, fibre, fabric or yarn.

In some embodiments, the graphene incorporated polymer is drawn into a fibre at a particular temperature and draw ratio.

In some embodiments, the graphene incorporated polymer is drawn into a fibre at a particular temperature and draw ratio, followed by spinning the fibre to form a spun yarn.

In some embodiments, the graphene incorporated polymer is drawn into a fibre at a particular temperature and draw ratio, followed by spinning the fibre to form a spun yarn, which is further optionally texturized.

In some embodiments, the graphene incorporated polymer is drawn into a fibre at a particular temperature and draw ratio, followed by spinning the fibre to form a spun yarn, which is further optionally texturized, and drawn into a particular shape and width.

In some embodiments, the graphene incorporated polymer is drawn into a fibre or filament and optionally spun together, with varying thickness.

In some embodiments, the cross section/shape of the fibre or filament is altered to get the desired appearance with improved properties.

The polymer fibre and the corresponding yarn or fabric obtained by the aforesaid process retains at least one or more of the anti-microbial, antistatic, anti-odour, wicking, thermal cooling and ultraviolet protection features for up to at least 20 washes.

In some embodiments, the polymer fibre and the corresponding yarn or fabric obtained by the aforesaid process retains at least one or more of the anti-microbial, antistatic, anti-odour, wicking, thermal cooling and ultraviolet protection features for the life of the fibre/fabric.

In some embodiments of the present disclosure, the preparation/production of graphene infused polymer fabric is achieved by a one-step industrially adapted large-scale mass production polymerization process without the involvement of post processing techniques.

As mentioned previously, the graphene containing polymer fibre/fabric prepared by the process as described herein is characterized by one or more of the following
about 1 fold to about 10 fold increase in anti-microbial activity;
about 10% to about 200% increase in thermal cooling; and
about 10% to about 60% increase in ultraviolet protection,
when compared to a polymer fabric lacking graphene.

The present disclosure further relates to use of graphene for preparing a polymer fibre or fabric comprising graphene at an amount ranging from about 0.0001% to 1% (w/w), or about 1 ppm to about 10000 ppm and characterized by feature selected from a group comprising anti-microbial, antistatic, anti-odour, wicking, thermal cooling and ultraviolet protection, or any combination thereof.

In some embodiments, the use comprises preparing a graphene slurry comprising graphene at a concentration higher than that at which it is present in the final polymer fabric and mixing the same with polymer precursor prior to the process of polymerization to obtain the graphene incorporated or infused polymer. The graphene infused polymer was then drawn into the filament/fibre/yarn to prepare a suitable fabric. The corresponding polymer fibre/fabric that is yielded comprises graphene at a concentration of about 0.0001 wt % to 1 wt % or about 1 ppm to about 10000 ppm, as defined herein.

As mentioned above, the graphene in the aforesaid use is a graphene, a graphene derivative or a combination thereof, wherein the graphene derivative is preferably a multi-layered graphene. The said graphene is a combination of single and multi-layered graphene, and comprises about 80% to about 85% of single layered graphene, and about 15% to about 20% multi-layered graphene, wherein the multi-layered graphene is made up of about 2 to about 5 layers of graphene.

In some embodiments, in the aforesaid use, the graphene is in the form of a graphene slurry. In some embodiments, the graphene slurry comprises graphene, solvent and optionally a surfactant.

In some embodiments, the graphene is in a form of a graphene slurry comprising graphene, solvent and optionally a surfactant. The graphene in said slurry is a graphene, a graphene derivative or a combination thereof, preferably multi-layered graphene. In some embodiments, the ratio between the graphene and the surfactant in the graphene slurry ranges from about 1:280 to 2:1. Solvents, surfactants and graphene derivatives employable herein are defined in earlier embodiments.

The present disclosure also provides a method of improving one or more characteristic of a polymer fibre or fabric, said method comprising act of incorporating graphene or its derivative prior to the step of polymerization during the process of preparing the polymer.

In some embodiments, the graphene is incorporated prior to the step of polymerization but after the step of esterification, during the process of preparing the polymer.

In some embodiments, the characteristic of the polymer fibre or fabric that is improved is selected from a group comprising anti-microbial, antistatic, anti-odour, wicking, thermal cooling and ultraviolet protection, or any combination thereof.

In some embodiments, at least two, at least three, at least four, at least five or all six characteristics of a polymer fibre or fabric are improved by employing the method of the present disclosure.

In some embodiments, the method improves at least two characteristics of a polymer fibre or fabric by at least about 10% when compared to a polymer fibre or fabric lacking graphene or its derivative.

In some embodiments, the incorporation of graphene improves the characteristics of the polymer fibre or fabric by the method of incorporating graphene into the polymer prior to the step of polymerization as follows
about 1 fold to about 10 fold increase in anti-microbial activity;
about 10% to about 200% increase in thermal cooling; and
about 10% to about 60% increase in ultraviolet protection,
when compared to a polymer fibre or fabric lacking graphene.

In some embodiments, the present disclosure provides a method of improving one or more characteristic of a polymer fibre or fabric, said method comprising act of incorporating graphene prior to the step of polymerization during the process of preparing the polymer, wherein the graphene or its derivative is present at an amount of about 0.0001 wt % to 1 wt %, or about 1 ppm to about 10000 ppm with respect to the final polymer. In some embodiments, the amount of graphene ranges from about 50 ppm to about 200 ppm, and the graphene is preferably a multi-layered graphene, and has a surface area ranging from about 300 m²/g to about 800 m²/g, or about 400 m²/g to about 500 m²/g, and wherein the graphene is a combination of single and multi-layered graphene, and comprises about 80% to about 85% of single layered graphene, and about 15% to about 20% multi-layered graphene, wherein the multi-layered graphene is made up of about 2 to about 5 layers of graphene.

In some embodiments, the polymer is a natural polymer or a synthetic polymer. In some embodiments, the polymer is polyester.

The present disclosure further provides use of the graphene infused polymer fibre or fabric in applications/manufacture of commercial products such as but not limited to textile products for personal use, for medical applications/hospitals such as aprons, garments, furniture covers, bed covers, pillow covers, curtains, other apparels, upholstery, carpets and bags.

In some embodiments, the said commercial products is also accordingly characterized by a feature selected from a group comprising anti-microbial, antistatic, anti-odour, wicking, thermal cooling and ultraviolet protection, or any combination thereof.

In some embodiments, the said commercial products are made up of polymer fibres or fabric that comprises graphene at an amount of about 0.0001 wt % to 1 wt % or about 1 ppm to about 10000 ppm. In some embodiments, the amount ranges from about 50 ppm to about 200 ppm, and the graphene is preferably a multi-layered graphene, and has a surface area ranging from about 300 m²/g to about 800 m²/g, or about 400 m²/g to about 500 m²/g.

In some embodiments, the polymer is a natural polymer or a synthetic polymer. In some embodiments, the polymer is polyester.

As also mentioned above, the graphene employed in the present disclosure is a combination of single and multi-layered graphene, and comprises about 80% to about 85% of single layered graphene, and about 15% to about 20% multi-layered graphene, wherein the multi-layered graphene is made up of about 2 to about 5 layers of graphene. This description of the graphene and its composition is fulfilled by the graphene that is employed to prepare the graphene slurry in the present disclosure, as well as by the graphene that is present in the final product, i.e., polymer fibre or fabric comprising graphene.

As mentioned in this disclosure, the concentration of graphene within the slurry prepared herein ranges from about 0.0001 wt % to about 7 wt %. Accordingly, in some embodiments, any of the said concentration values ranging from about 0.0001 wt % to about 7 wt % comprises about 80% to about 85% of single layered graphene, and about 15% to about 20% multi-layered graphene, wherein the multi-layered graphene is made up of about 2 to about 5 layers of graphene. Hence, for example, if the concentration of graphene within the slurry is about 2 wt %, about 80% to about 85% of this 2 wt % is made up of single layered graphene, and about 15% to about 20% of this 2 wt % is made up of multi-layered graphene, wherein the multi-layered graphene is made up of about 2 to about 5 layers of graphene.

Similarly, as mentioned in this disclosure, the amount of graphene within the polymer fibre or fabric prepared herein ranges from about 0.0001% (w/w) to about 1% (w/w), or about 1 ppm to about 10000 ppm. Accordingly, in some embodiments, any of the said amounts ranging from about 0.0001% (w/w) to about 1% (w/w), or about 1 ppm to about 10000 ppm comprises about 80% to about 85% of single layered graphene, and about 15% to about 20% multi-layered graphene, wherein the multi-layered graphene is made up of about 2 to about 5 layers of graphene. Hence, for example, if the amount of graphene within the polymer fibre or fabric is about 100 ppm, about 80% to about 85% of this 100 ppm is made up of single layered graphene, and about 15% to about 20% of this 100 ppm is made up of multi-layered graphene, wherein the multi-layered graphene is made up of about 2 to about 5 layers of graphene.

It is important to note that while single layer graphene has all the desired attributes in its highest form, obtaining a 100% single layer graphene requires labour intensive processes and thus increases the cost. Moreover, 100% single layer graphene has extremely high surface area which makes it difficult to process. These drawbacks are overcome by use of a graphene composition which is a combination of single and multi-layered graphene, and comprises about 80% to about 85% of single layered graphene, and about 15% to about 20% multi-layered graphene, wherein the multi-layered graphene is made up of about 2 to about 5 layers of graphene. Such a combination of graphene possesses all the required attributes for preparing the product (polymer fibre or fabric) of the present disclosure with surface areas that are optimum for processing. However, it is crucial to note that arriving at such a graphene combination that comprises both single and multi-layered graphene is not direct and straightforward. This is because the surface area of a graphene is inversely proportional to the number of layers present in the said graphene. When the number of layers increases, the available surface area decreases and vice versa. While a very low surface area (with high number of layers) is detrimental as it adversely impacts the resulting properties and outcome, a very high surface area also makes processing of the graphene so much more challenging and process intensive. Thus, a critical balance between the number of layers and the surface area of the selected graphene is required to achieve the desired results in the present disclosure.

Thus, to solve the need in the art for enhanced polymer fibres or fabrics, the present disclosure provides polymer fibre/fabric comprising graphene at relatively low concentration, to obtain the claimed polymer fibre/fabric. Advantages of the polymer fibre/fabric of the present disclosure include but are not limited to
beneficial properties at low concentrations of graphene and/or its derivatives;
very good/excellent washing fastness, rubbing fastness, perspiration fastness, sublimation fastness and light fastness, that is retained for the lifetime of the fibre
retention of the beneficial properties discussed above along with excellent washing, rubbing, perspiration, sublimation and light fastness features up to the life of the fibre, even after multiple washes of the polymer fabric thus providing excellent stability to the polymer fabric after repeated washing cycles, and the life of the fibre/fabric;
enhanced anti-microbial, antistatic, anti-odour, wicking, thermal cooling and ultraviolet protection as compared to unprocessed polymer fabrics without compromising the hand-feel, texture and visual aspects of the final fabric, which is retained for the life of the fibre/fabric;
incorporation of all the said properties in one step integrated process without additional processing steps, cost, manpower and time, along with increase the strength of the fibre/fabric; and
economical, repeatable and commercially/industrially viable process for production.

While the present disclosure is susceptible to various modifications and alternative forms, specific aspects thereof have been shown by way of examples are described in detail below. However, it should be understood that it is not intended to limit the invention to the particular forms disclosed, but on the contrary, the intention is to cover all modifications, equivalents, and alternatives falling within the spirit and the scope of the invention as defined by the appended claims.

### EXAMPLES

The present disclosure is further described with reference to the following examples, which are only illustrative in nature and should not be construed to limit the scope of the present disclosure in any manner

The graphene employed in the following examples is a combination of single and multi- layered graphene, and comprises about 80% to about 85% of single layered graphene, and about 15% to about 20% multi-layered graphene, wherein the multi-layered graphene is made up of about 2 to about S layers of graphene. This graphene has a surface area of about 300 to about 600 m 2 /g.

### Example 1: Preparation of a Control Fabric and Testing of its Properties

For preparing a batch size of about 55 kg, about 47.3 kg of purified terephthalic acid (PTA) and about 35.5 kg of mono ethylene glycol (MEG) were mixed to prepare a polymer precursor slurry. The mole ratio of the polymer precursor to the solvent was maintained at about 1:2. Further, about 990 gms of isophthalic acid (IPA) was also added in PTA-MEG precursor slurry. Thereafter, antimony trioxide was added as a catalyst, in a manner so as to provide about 290 ppm of antimony. During the condensation polymerization process, to prevent formation of contaminants, such as diethylene glycol (DEG), NaOH was added in a manner so as to provide about 25 ppm of sodium. The mixture was then subjected to esterification at about 262° C.

Once esterification was completed, phosphoric acid was added to provide about 10 ppm of phosphorus along with TiO₂ of 0.25%. Condensation polymerization was then carried out under fine vacuum (<0.5 torr) at about 290° C. After achieving desired viscosity, the polymer was taken out and drawn into a fibre or filament, which was finally used to prepare the control fabric.

The control fabric of this example where no graphene was incorporated, revealed no efficacy against Staphylococcus aureus and against Klebsiella pneumonia, when analyzed as per JISL 1902 test method. Moreover, the said fabric demonstrated wet Qₘₐₓ value of 0.25 W/cm² and dry Qₘₐₓ value of 0.16 W/cm² as per KAWABATA System using KES -F7 instructions. Additionally, the said graphene deficient fabric was also characterized by mean UV protection factor which was 183.61 as per AATCC 183-2014 test method.

### Example 2: Preparation of a Graphene Infused Fabric and Testing of its Properties

A MEG-based graphene slurry is prepared using high shear mixer. 1 kg graphene is dispersed in 49 kg MEG for 3 hours using high shear mixer to obtain a homogeneous and concentrated slurry. About 0.2 kg surfactant is added in the said amount of water and mixed for 15 minutes prior to the graphene addition step. The prepared graphene slurry is used as a source of graphene during polymerization process for obtaining graphene infused polymer fibre where the concentration of graphene is 2%.

For preparing a batch size of about 55 kg, about 47.3 kg of purified terephthalic acid (PTA) and about 35.5 kg of mono ethylene glycol (MEG) were mixed to prepare a polymer precursor slurry. The mole ratio of the polymer precursor to the solvent was maintained at about 1:2. Further, about 990 gms of isophthalic acid (IPA) was also added in PTA-MEG precursor slurry. Thereafter, antimony trioxide was added as a catalyst, in a manner so as to provide about 290 ppm of antimony. During the condensation polymerization process, to prevent formation of contaminants, such as diethylene glycol (DEG), NaOH was added in a manner so as to provide about 25 ppm of sodium. The mixture was then subjected to esterification at about 262° C.

Once esterification was completed, 137.5 gm of pre-prepared 2% graphene slurry was added to reach the graphene concentration of 50 ppm. Subsequently, phosphoric acid was added to provide about 10 ppm of phosphorus along with TiO₂ of 0.25%. Condensation polymerization was then carried out under fine vacuum (<0.5 torr) at about 290° C. After achieving desired viscosity, the graphene incorporated polymer was taken out and drawn into a fibre or filament, which was finally used to prepare the graphene infused fabric.

The graphene incorporated fabric of this example that comprises graphene and/or its derivatives at a concentration of 50 ppm, revealed antimicrobial effect of 3.1 against Staphylococcus aureus and Klebsiella pneumonia, which was maintained even after 20 washes, when analyzed as per JISL 1902 test method. The said fabric demonstrated wet Qₘₐₓ value of 0.28 W/cm², which remained at 0.27 W/cm² even after 20 washes. The described fabric showed dry Qₘₐₓ value of 0.19 W/cm², which remained at 0.18 W/cm² even after 20 washes as per KAWABATA System using KES-F7 instructions. The said fabric also maintained an average of 87 mm vertical moisture wicking height for 30 mins (warp) and 79 mm average vertical moisture wicking height for 30 mins (weft) even after 20 washes according to AATCC 197:2013 method. The said graphene incorporated fabric was also characterized by mean UV protection factor which was 203.16 even after 20 washes as per AATCC 183-2014 test method.

### Example 3: Preparation of a Graphene Infused Fabric and Testing of its Properties

The procedure and the components employed in this example remained the same as described in Example 2 above, with the only difference being in terms of the concentration of graphene used. After the esterification was completed, 412.5 gm of pre-prepared 2% graphene slurry was added to reach the graphene concentration of 150 ppm.

The graphene incorporated fabric of this example that comprises graphene and/or its derivatives at a concentration of 150 ppm, showed antimicrobial effect of 3.2 against Staphylococcus aureus and Klebsiella pneumonia, which was maintained even after 20 washes, when analyzed as per JISL 1902 test method. The said fabric demonstrated wet Qₘₐₓ value of 0.32 W/cm², which remained at 0.25 W/cm² even after 20 washes. The described fabric demonstrated dry Qₘₐₓ value of 0.21 W/cm², which remained at 0.17 W/cm² even after 20 washes as per KAWABATA System using KES-F7 instructions. The said fabric also maintained an average of 91 mm vertical moisture wicking height for 30 mins (warp) and 81.6 mm average vertical moisture wicking height for 30 mins (weft) even after 20 washes according to AATCC 197:2013 method. The said graphene incorporated fabric was also characterized by mean UV protection factor which was 271.19 even after 20 washes as per AATCC 183-2014 test method.

### Example 4: Preparation of a Graphene Infused Fabric and Testing of its Properties

The procedure and the components employed in this example remained the same as described in Example 2 above, with the only difference being in terms of the concentration of graphene used. After the esterification was completed, 550 gm of pre-prepared 2% graphene slurry was added to reach the graphene concentration of 200 ppm.

The graphene incorporated fabric of this example that comprises graphene and/or its derivatives at a concentration of 200 ppm, showed antimicrobial effect of 3.3 against Staphylococcus aureus and Klebsiella pneumonia, which was maintained even after 20 washes, when analyzed as per JISL 1902 test method. The said fabric revealed wet Qₘₐₓ value of 0.32 W/cm², which remained at 0.3 W/cm² even after 20 washes. The described fabric demonstrated dry Qₘₐₓ value of 0.25 W/cm², which remained at 0.2 W/cm² even after 20 washes as per KAWABATA System using KES -F7 instructions. The said fabric also maintained an average of 105 mm vertical moisture wicking height for 30 mins (warp) and 82 mm average vertical moisture wicking height for 30 mins (weft) even after 20 washes according to AATCC 197:2013 method. The said graphene incorporated fabric was also characterized by mean UV protection factor which was 275.26 even after 20 washes, as per AATCC 183-2014 test method. Further, the said graphene incorporated fabric was also studied for its water absorbency which was 2.5 seconds, as per AATCC 79:2014 test method.

All results from examples 1 to 4 have been summarized in the Table 2 below:

TABLE 2

| | | | | UV | |
|---|---|---|---|---|---|
| | Antimicrobial | | | Protection | |
| Example | Effect (JIS L | Wet Qₘₐₓ | Dry Qₘₐₓ | Factor | Wicking |
| No. | 1902) | (KES) | (KES) | (AATCC) | (AATCC) |
| Example 1 | No Efficacy | 0.25 W/cm² | 0.16 W/cm² | 183.61 | NA |
| Example 2 | 3.1 | 0.28 W/cm² | 0.19 W/cm² | 203.16 | 87 mm (Warp) |
| | | | | | 79 mm (Weft) |
| Example 3 | 3.2 | 0.32 W/cm² | 0.21 W/cm² | 271.19 | 91 mm (Warp) |
| | | | | | 81.6 mm (Weft) |
| Example 4 | 3.3 | 0.32 W/cm² | 0.25 W/cm² | 275.26 | 105 mm (Warp) |
| | | | | | 82 mm (Weft) |

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

Throughout this specification, the word “comprise”, or variations such as “comprises” or “comprising” wherever used, will be understood to imply the inclusion of a stated element, integer or step, or group of elements, integers or steps, but not the exclusion of any other element, integer or step, or group of elements, integers or steps. Similarly, terms such as “include” or “have” or “contain” and all their variations are inclusive and will be understood to imply the inclusion of a stated element, integer or step, or group of elements, integers or steps, but not the exclusion of any other element, integer or step, or group of elements, integers or steps.

The terms “about” or “approximately” are used herein to mean approximately, in the region of, roughly, or around. When the term “about” is used in conjunction with a numerical value/range, it modifies that value/range by extending the boundaries above and below the numerical value(s) set forth. In general, the term “about” is used herein to modify a numerical value(s) or a measurable value(s) such as a parameter, an amount, a temporal duration, and the like, above and below the stated value(s) by a variance of +/−20% or less, +/−10% or less, +/−5% or less, +/−1% or less, and +/−0.1% or less of and from the specified value, insofar such variations are appropriate to perform in the disclosed invention, and achieves the desired results and/or advantages as disclosed in the present disclosure. It is to be understood that the value to which the modifier “about” or “approximately” refers is itself also specifically, and preferably, disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an” and “the” includes both singular and plural references unless the content clearly dictates otherwise. The use of the expression ‘at least’ or ‘at least one’ suggests the use of one or more elements or ingredients or quantities, as the use may be in the embodiment of the disclosure to achieve one or more of the desired objects or results. As such, the terms “a” (or “an”), “one or more”, and “at least one” can be used interchangeably herein.

Numerical ranges stated in the form ‘from x to y’ include the values mentioned and those values that lie within the range of the respective measurement accuracy as known to the skilled person. If several preferred numerical ranges are stated in this form, of course, all the ranges formed by a combination of the different end points are also included.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

All references, articles, publications, general disclosures etc. cited herein are incorporated by reference in their entireties for all purposes. However, mention of any reference, article, publication etc. cited herein is not, and should not be taken as, an acknowledgment or any form of suggestion that they constitute valid prior art or form part of the common general knowledge in any country in the world.

1. A polymer fiber or fabric comprising graphene or its derivative
wherein an amount of the graphene or its derivative in the polymer fiber or fabric is from about 0.0001% (w/w) to about 1% (w/w), or about 1 ppm to about 10000 ppm,
wherein the graphene is incorporated within the polymer, and the polymer fiber or fabric is characterized by a feature selected from the group consisting of anti-microbial, antistatic, anti-odour, wicking, thermal cooling and ultraviolet protection, or any combination thereof.

2. The polymer fiber or fabric as claimed in claim 1, wherein the graphene is a combination of a single-layered graphene and a multi-layered graphene, and comprises about 80% to about 85% of the single-layered graphene, and about 15% to about 20% of the multi-layered graphene, wherein the multi-layered graphene is made up of about 2 to about 5 layers of graphene.

3. The polymer fiber or fabric as claimed in claim 1, wherein the graphene has a surface area ranging from about 300 m²/g to about 800 m²/g, or about 400 m²/g to about 500 m²/g.

4. The polymer fiber or fabric as claimed in claim 1, wherein the polymer is a natural polymer or a synthetic polymer; or wherein the polymer is polyester.

5. The polymer fiber or fabric as claimed in claim 1, wherein the graphene is incorporated within the polymer at an amount ranging from about 50 ppm to about 500 ppm; or at an amount ranging from about 50 ppm to about 200 ppm.

6. The polymer fiber or fabric as claimed in claim 1, characterized by at least two features selected from the group consisting of anti-microbial, antistatic, anti-odour, wicking, thermal cooling and ultraviolet protection, or any combination thereof.

7. The polymer fiber or fabric as claimed in claim 6, characterized by a combination of anti-microbial, wicking, thermal cooling and ultraviolet protection features.

8. The polymer fiber or fabric as claimed in claim 1, wherein at least one of the features is enhanced by at least about 10% when compared to a polymer fiber or fabric lacking graphene or its derivative.

9. The polymer fiber or fabric as claimed in 8, wherein:
a. the anti-microbial activity is enhanced by about 1 fold to about 10 folds;
b. the thermal cooling is enhanced by about 10% to about 200%; and
c. the ultraviolet protection is enhanced by about 10% to about 60%,
when compared to a polymer fiber or fabric lacking graphene or its derivative:,
or wherein the anti-microbial, antistatic, anti-odour, wicking, thermal cooling, and ultraviolet protection features of the polymer fiber or fabric are maintained up to a life of the fiber or fabric or at least 20 washes.

10. (canceled)

11. A process of preparing the polymer fiber or fabric as claimed in claim 1, said process comprising incorporating graphene or its derivative during a synthesis of the polymer, and drawing the polymer into a fiber optionally followed by converting it to a fabric.

12. The process as claimed in claim 11, wherein the graphene or its derivative is incorporated after an esterification of the polymer precursors, but prior to a polymerization of the said precursors, during the synthesis of the polymer.

13. The process as claimed in claim 11, comprising steps of:
a. preparing a slurry of graphene or its derivative;
b. mixing an esterified mixture of polymer precursor with the graphene slurry; and
c. subjecting the mixture to polymerization to prepare the polymer comprising graphene or its derivative.

14. The process as claimed in claim 13, comprising:
a. mixing a polymer precursor with an organic solvent to form a polymer precursor slurry;
b. optionally adding a catalyst and/or a contaminant suppressant to the slurry;
c. esterifying the slurry of said (a) or (b) to obtain an esterified mixture;
d. adding a slurry of graphene or its derivative prepared in an organic solvent to the esterified mixture;
e. subjecting the mixture obtained at the end of said (d) to polymerization to prepare the graphene incorporated polymer.

15. The process as claimed in claim 14, wherein the polymer precursor is selected from the group consisting of ethylene glycol, terephthalic acid, isophthalic acid, propylene, 1,4-butane diol, dimethyl terephthalate, 1,3-propane diol, other appropriate diols, naphthalene-2,6-dicarboxylic acid, furan dicarboxylic acid and lactic acid, or any combination thereof; and wherein the organic solvent employed to form the polymer precursor slurry is selected from the group consisting of mono ethylene glycol (MEG), propylene glycol, butylene glycol and propylene glycol, or any combination thereof; or
wherein the polymer precursor is mixed with the organic solvent at a mole ratio ranging from about 1:1.8 to about 1:2.2; or
wherein the slurry of graphene or its derivative is a stable dispersion of graphene or its derivative in an organic solvent selected from the group consisting of MEG, 1,4-butane diol, dimethyl terephthalate, 1,3-propane diol, other appropriate diols, and lactic acid, or any combination thereof; and wherein a concentration of the graphene or its derivative within the slurry ranges from about 0.0001 wt % to about 7 wt %; or
wherein the slurry of graphene or its derivative is a stable dispersion of graphene or its derivative in an organic solvent selected from the group consisting of MEG, 1,4-butane diol, dimethyl terephthalate, 1,3-propane diol, other appropriate diols, and lactic acid, or any combination thereof; and wherein a concentration of the graphene or its derivative within the slurry ranges from about 0.0001 wt % to about 7 wt %.

16. (canceled)

17. (canceled)

18. The process as claimed in claim 14, wherein the catalyst is an antimony, titanium or germanium based catalyst; and wherein an amount of the catalyst is chosen such that the polymer precursor slurry contains about 30 ppm to about 300 ppm of the catalyst's primary element.

19. The process as claimed in claim 14, wherein the contaminant suppressant is an alkali base; or wherein the contaminant suppressant is NaOH; and wherein an amount of the suppressant is chosen such that the polymer precursor slurry contains about 10 ppm to about 50 ppm of the alkali metal.

20. The process as claimed in claim 14, wherein the esterification is carried out at a temperature ranging from about 240° C. to about 292° C., and at a pressure ranging from about 1 bar to about 5 bar; or
wherein the slurry of graphene or its derivative is added to the esterified mixture at an amount such that post the addition, the polymer contains about 1 ppm to about 10000 ppm of graphene or its derivative.

21. (canceled)

22. The process as claimed in claim 13, wherein the polymerization is a condensation polymerization; or
wherein the graphene is a combination of single and multi-layered graphene, and comprises about 80% to about 85% of the single-layered graphene, and about 15% to about 20% of the multi-layered graphene, wherein the multi-layered graphene is made up of about 2 to about 5 layers of graphene; and wherein the graphene has a surface area ranging from about 300 m²/g to about 800 m²/g, or about 400 m²/g to about 500 m²/g; and wherein the polymer is polyester.

23. (canceled)

24. A method of improving one or more characteristic of a polymer fiber or fabric, comprising an act of incorporating graphene or its derivative during a synthesis of the polymer.

25. The method as claimed in claim 24, wherein the graphene or its derivative is incorporated after an esterification of the polymer precursors, but prior to a polymerization of the said precursors, during the synthesis of the polymer; or
wherein the characteristic is selected from the group consisting of anti-microbial, antistatic, anti-odour, wicking, thermal cooling, and ultraviolet protection, or any combination thereof; and wherein the method improves at least two characteristics of a polymer fiber or fabric by at least about 10% when compared to a polymer fiber or fabric lacking graphene or its derivative; or
wherein the graphene is a combination of single and multi-layered graphene, and comprises about 80% to about 85% of the single-layered graphene, and about 15% to about 20% of the multi-layered graphene, wherein the multi-layered graphene is made up of about 2 to about 5 layers of graphene; and wherein the graphene has a surface area ranging from about 300 m²/g to about 800 m²/g, or about 400 m²/g to about 500 m²/g; and wherein the polymer is polyester.

26. (canceled)

27. (canceled)
